(19) United States
(12) Patent Application Publication
(10) Pub. No.: US 2026/0342958 A1
(43) Pub. Date: Oct. 29, 2026

(54) STEREOSCOPIC IMAGE DISPLAY DEVICE

(71) Applicant: LG DISPLAY CO., LTD., SEOUL (KR)

(72) Inventor: Gyusuk Jung, Seoul (KR)

(21) Appl. No.: 19/647,996

(22) Filed: Apr. 15, 2026

(30) Foreign Application Priority Data
Apr. 23, 2025 (KR) 10-2025-0053047

(51) Int. Cl. H04N 13/398; H04N 13/305; H04N 13/324; H04N 13/383

(52) U.S. Cl. CPC H04N 13/398; H04N 13/305; H04N 13/324; H04N 13/383

(57) ABSTRACT

A stereoscopic image display device includes a display panel which assigns and outputs view data in a stereo form from a first view to a mth view sequentially to respective m subpixels (where m is a natural number), and an optical lens which is disposed on a front surface of the display panel to separate an optical axis of the output view data to form a left eye image (L-view image) and a right eye image (R-view image) at a viewing distance, the display panel identifying a subpixel in which the L-view image and the R-view image are overlapping among the m subpixels according to a change in a position of a viewer, and adjusts a grayscale value of the identified subpixel to output, thereby reducing a deterioration in image quality caused by a change in the position of a viewer.

Pursuant to 35 U.S.C. § 119(a), this application claims the benefit of an earlier filing date and right of priority to Korean Patent Application No. 10-2025-0053047 filed on Apr. 23, 2025, in the Ministry of Intellectual Property of the Republic of Korea, the entire disclosure of which is incorporated herein by reference.

### TECHNICAL FIELD

The present disclosure relates to a stereoscopic image display device.

### BACKGROUND

A 3D display system can artificially implement a three-dimensional (3D) image. For example, the system includes both software technologies capable of presenting images in 3D and hardware configured to reproduce, in a 3D manner, content generated using such technologies.

Among these 3D displays, a virtual 3D display (hereinafter, referred to as a stereoscopic image display device) uses a binocular disparity, which is one of several factors by which humans perceive depth. Binocular disparity refers to a parallax that occurs because of the spacing between a human’s eyes, which are spaced apart by approximately 65 mm. This binocular disparity causes the same object to be perceived from different angles, and as a result, humans can perceive a three-dimensional sense of space.

The description provided in the background section should not be assumed to be prior art merely because it is mentioned in or associated with this section. The background section may include information that describes one or more aspects of the subject technology, and the description in this section does not limit the scope of the present disclosure.

### SUMMARY

According to an implementation of the present disclosure, a stereoscopic image display device includes a display panel which sequentially assigns and outputs view data in the form of a stereo from a first view to a mth view to respective m subpixels (where m is a natural number) and an optical lens which is disposed on a front surface of the display panel to separate an optical axis of the output view data and form a left-eye image (L-view image) and a right-eye image (R-view image) at a viewing distance, wherein the display panel identifies a subpixel in which the L-view image and the R-view image are overlapping among the m subpixels according to a change in the position of a viewer, and adjusts and outputs a grayscale value of the identified subpixel.

A stereoscopic image display device according to another example implementation of the present disclosure includes a substrate including a plurality of subpixels, each subpixel including one emission area, a light emitting element disposed in the emission area of the subpixel, a color filter disposed above the light emitting element and overlapping the emission area of the subpixel, and an optical lens disposed on a front surface of the color filter to form a left-eye image (L-view image) and a right-eye image (R-view image) at a viewing distance, and according to a change in the position of a viewer, a subpixel in which the L-view image and the R-view image overlap among the plurality of subpixels may be identified, and a grayscale value of the identified subpixel may be reduced and output.

According to another example implementation of the present disclosure, a stereoscopic image display device, comprising: a substrate including a plurality of subpixels, each subpixel including one emission area; a light emitting element disposed in the emission area of the subpixel; a color filter disposed above the light emitting element and overlapping the emission area of the subpixel; and an optical lens disposed on a front surface of the color filter and forming a left-eye image expressed as L-view image and a right-eye image expressed as R-view image at a viewing distance, wherein according to a change in the position of a viewer, a subpixel in which the L-view image and the R-view image are overlapping among the plurality of subpixels is identified, and the grayscale value of the identified subpixel is reduced and output.

According to another example implementation of the present disclosure, a stereoscopic image display apparatus includes a display panel, wherein the display panel outputs view data through one or more subpixels; a light separation element disposed over the display panel, wherein the view data output from the display panel passes through the light separation element to provide a binocular parallax image, the binocular parallax image including a left-eye image and a right-eye image; and wherein the left-eye image has (i) a left-eye first light distribution region in a region at a center of the left-eye image, and (ii) a left-eye second light distribution region in an overlapping region with the right-eye image; wherein the right-eye image has (i) a right-eye first light distribution region in a region at a center of the right-eye image, and (ii) a right-eye second light distribution region in an overlapping region with the left-eye image; and wherein the stereoscopic image display apparatus is configured to, when a viewing region is not located in the region at the center of the left-eye image or the region at the center of the right-eye image, reduce a light distribution intensity of the right-eye second light distribution region and/or reduce a light distribution intensity of the left-eye second light distribution region to reduce crosstalk between the left-eye image and the right-eye image.

Other detailed matters of the implementations are included in the detailed description and the drawings.

According to some implementations of the present disclosure, by adjusting the grayscale value of 3D input data in units of subpixel based on the position information of the viewer, it is possible to effectively reduce the crosstalk, which is an interference phenomenon between stereoscopic images, even when the viewer deviates from the optimal viewing distance OVD.

In addition, according to some implementations of the present disclosure, it is possible to minimize degradation of 3D image quality caused by changes in the viewer’s position while maintaining a fixed optical structure. As a result, a stable stereoscopic effect and enhanced visual immersion can be provided even over a wider viewing distance and a viewing angle. In addition, since crosstalk can be corrected using only an image processing algorithm without modifying complex optical structures, the design flexibility and implementation efficiency of the system can be improved.

The effects according to some implementations of the present disclosure are not limited to the contents exemplified above, and more various effects are included in the present disclosure. Additional features and aspects will be set forth in part in the description that follows, and in part will become apparent from the description, or may be learned by practice of the inventive concepts provided herein.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view schematically illustrating an example of a stereoscopic image display device according to an implementation of the present disclosure.

FIG. 2 is a circuit diagram of an example of a subpixel of the stereoscopic image display device of FIG. 1.

FIG. 3 is an enlarged view of an example of part A of FIG. 1.

FIG. 4 is a view illustrating a cross-sectional structure of an example of a part A of FIG. 1.

FIG. 5A is a diagram schematically illustrating an example of a state in which a stereoscopic image is viewed through a stereoscopic image display device according to an implementation of the present disclosure at an optimal viewing distance (OVD).

FIG. 5B is a graph illustrating examples of light profiles and crosstalk of images provided to a left eye and a right eye in the stereoscopic image display device of FIG. 5A.

FIG. 6A is a diagram schematically illustrating an example of a state in which a stereoscopic image is viewed through stereoscopic image display device according to an implementation of the present disclosure at a distance closer than the OVD.

FIGS. 6B and 6C are graphs showing examples of light profiles and crosstalk of images provided to a left eye and a right eye in the stereoscopic image display device of FIG. 6A, wherein FIG. 6B illustrates a crosstalk map before adjustment, and FIG. 6C illustrates a crosstalk map after adjustment.

FIG. 7A is a diagram schematically illustrating an example of a state in which a stereoscopic image is viewed through stereoscopic image display device according to an implementation of the present disclosure at a distance farther than the OVD.

FIGS. 7B and 7C are graphs showing examples of light profiles and crosstalk of images provided to a left eye and a right eye in the stereoscopic image display device of FIG. 7A, wherein FIG. 7B illustrates a crosstalk map before adjustment, and FIG. 7C illustrates a crosstalk map after adjustment.

FIG. 8A is a diagram schematically illustrating an example of a method of implementing a stereoscopic image display device in an OVD.

FIG. 8B is a diagram schematically illustrating an example of a method of implementing a stereoscopic image display device by applying grayscale value adjustment of the present disclosure at a distance farther than an OVD.

FIG. 9A is a diagram illustrating an example of a state in which a stereoscopic image is viewed at a position where a viewing angle is slightly deviated from the front surface through a stereoscopic image display device according to an implementation of the present disclosure.

FIGS. 9B and 9C are graphs showing examples of light profile and a crosstalk of an image provided to a left eye and a right eye in the stereoscopic image display device of FIG. 9A, wherein FIG. 9B illustrates a crosstalk map before adjustment, and FIG. 9C illustrates a crosstalk map after adjustment.

FIG. 10A is a diagram illustrating an example of a state in which a stereoscopic image is viewed at a position further outside a viewing angle through a stereoscopic image display device according to an implementation of the present disclosure.

FIGS. 10B and 10C are graphs showing examples of light profile and a crosstalk of an image provided to the left eye and the right eye in the stereoscopic image display device of FIG. 10A, wherein FIG. 10B illustrates a crosstalk map before adjustment, and FIG. 10C illustrates a crosstalk map after adjustment.

FIG. 11 is a diagram schematically illustrating an example of a method of implementing a stereoscopic image display device by applying grayscale value adjustment of the present disclosure at a position where a viewing angle is slightly deviated from the front surface.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

A stereoscopic image display device can simultaneously display left and right images having different parallaxes on a flat display and deliver the left and right images separately to the respective eyes, thereby providing a visual effect as if a viewer were viewing an actual stereoscopic image. For example, the stereoscopic image display device may include an optical lens disposed on the light emitting element, and the optical lens may be configured as a lenticular lens extending in parallel in one direction, thereby enabling implementation of a stereoscopic image based on a light field method.

However, in some alternative technologies, the optical structure of a stereoscopic image display device is fixed, which imposes a limitation in that an optimal 3D stereoscopic effect may be provided only at an optimal viewing distance (OVD). When the viewer's viewpoint deviates from the OVD, this can result in a problem of increased crosstalk between left and right views. For example, when an observer is too close to or too far from the display, or when a lateral position of the observer deviates, the eyes of the observer may simultaneously fall within two viewing-angle windows of two viewpoints, or may fall at an edge of a viewing-angle window. Accordingly, crosstalk during viewing may increase, and ghost images may become more apparent. In other words, the crosstalk effect causes light that should enter only a certain viewpoint or a certain eye to leak into an adjacent viewpoint or the other eye, thereby deteriorating viewing performance. To improve this, some systems attempt to adjust the image output according to the viewer's viewpoint by applying eye-tracking technology, however, there remains a limitation in that crosstalk inevitably increases when the viewpoint exceeds a certain range.

Implementations of the present disclosure can provide a stereoscopic image display device capable of reducing crosstalk that may occur due to changes in a position of a viewer's viewpoint.

Some implementations of the present disclosure can provide a stereoscopic image display device which can effectively reduce crosstalk so that a stable stereoscopic effect can be maintained even when a viewer's viewpoint is out of an OVD or a viewing angle changes.

Implementations of the present disclosure can provide a stereoscopic image display device capable of mitigating inter-image interference that may occur according to a change in a position of a viewer and providing a natural 3D image at various viewpoints.

Implementations of the present disclosure can provide a stereoscopic image display device capable of reducing crosstalk only by grayscale value adjustment without changing an optical structure.

The technical effects described above are examples, and are not limited to the above-described technical effects. Other technical effects, which are not mentioned above, can be clearly understood by those skilled in the art from the following descriptions.

Advantages and characteristics of the present disclosure and a method of achieving the advantages and characteristics will be clear by referring to example implementations described below in detail together with the accompanying drawings. However, the present disclosure is not limited to the example implementations disclosed herein but will be implemented in various forms. The example implementations are provided by way of example only so that those skilled in the art can fully understand the disclosures of the present disclosure and the scope of the present disclosure.

The shapes, sizes, ratios, angles, numbers, and the like illustrated in the accompanying drawings for describing the example implementations of the present disclosure are merely examples, and the present disclosure is not limited thereto. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the disclosure.

A size and a thickness of each component illustrated in the drawing are illustrated for convenience of description, and the present disclosure is not limited to the size and the thickness of the component illustrated.

The features of various implementations of the present disclosure can be partially or entirely adhered to or combined with each other and can be interlocked and operated in technically various ways, and the implementations can be carried out independently of or in association with each other.

Hereinafter, various implementations of the present disclosure will be described in detail with reference to the accompanying drawings.

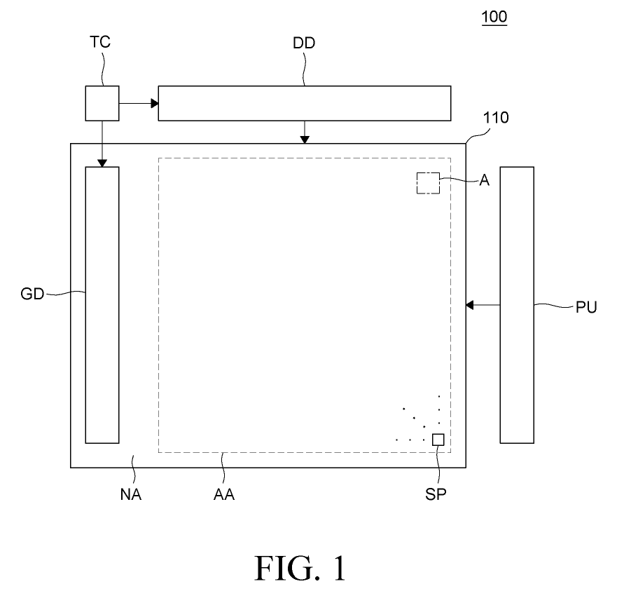

FIG. 1 is a view schematically illustrating a stereoscopic image display device according to an implementation of the present disclosure.

Referring to FIG. 1, a stereoscopic image display device 100 according to an implementation of the present disclosure may include a display panel 110.

The display panel 110 may be of various types such as an organic light emitting display panel and a liquid crystal display panel. Hereinafter, for convenience of description, the organic light emitting display panel will be described as an example.

The display panel 110 may generate an image provided to a viewer.

For example, a plurality of subpixels SP may be disposed in a matrix form in the display panel 110. Various signals may be applied to each subpixel SP through various signal lines GL, DL, and PL. For example, the signal lines GL, DL, and PL may include a gate line GL for applying a gate signal, a data line DL for applying a data signal, and a power voltage supply line PL for supplying a power voltage.

The gate line GL may be electrically connected to the gate driver GD. Further, the data line DL may be electrically connected to the data driver DD. In the implementation illustrated in FIG. 1, the gate driver GD may be located within the panel. However, the display device of the present disclosure is not limited thereto. In optional implementations, a gate driver on array substrate (Gate-on-Array, GOA), an external gate driver IC (e.g., COG, COF, etc.), and a hybrid gate driver may also be applied.

The gate driver GD and the data driver DD may be controlled by a timing controller TC. The gate driver GD may receive a clock signal, a reset signal, and a start signal from the timing controller TC, and the data driver DD may receive digital video data and a source timing signal from the timing controller TC.

Further, the power voltage supply line PL may be electrically connected to a power unit PU.

The display panel 110 may include a display area AA in which the plurality of subpixels SP is disposed, and a non-display area NA positioned outside the display area AA. For example, the non-display area NA may be located outside the display area AA. For example, the display area AA may be surrounded by the non-display area NA.

The display area AA is an area in which images are displayed in the stereoscopic image display device 100 and in the display area AA, a display element and various driving elements for driving the display element may be disposed.

For example, the display element may be configured as a light emitting element including a first electrode, an emission layer, and a second electrode.

In addition, various driving elements such as a thin film transistor, a capacitor, and a line for driving the display element may be disposed in the display area AA.

A plurality of subpixels SP may be disposed in the display area AA. The subpixel SP is a minimum unit constituting a screen, and each of the plurality of subpixels SP may include a light emitting element and a driving circuit. Further, each of the plurality of subpixels SP may emit light having different wavelengths. For example, the plurality of subpixels SP may include at least one red subpixel, a green subpixel, and a blue subpixel. Implementations of the present disclosure are not limited thereto, and the plurality of subpixels SP may further include a white subpixel.

Further, the driving circuit of the subpixel SP is a circuit for controlling driving of the light emitting element. For example, the driving circuit may include a thin film transistor and a capacitor, but is not limited thereto.

The non-display area NA is an area where no image is displayed and various components for driving the plurality of subpixels SP disposed in the display area AA may be disposed. For example, a driving IC which supplies a signal for driving the plurality of subpixels SP and a flexible film may be disposed.

The non-display area NA may be an area surrounding the display area AA as illustrated in FIG. 1. However, the present disclosure is not limited thereto. For example, the non-display area NA may be an area extending from the display area AA.

The gate driver GD, the data driver DD, the timing controller TC, and the power unit PU may be located outside the display area AA. For example, each of the signal lines GL, DL, and PL may include an area located on the non-display area NA.

At least one of the gate driver GD, the data driver DD, the timing controller TC, and the power unit PU may be located in the non-display area NA. For example, in the stereoscopic image display device 100 according to an implementation of the present disclosure, the gate driver GD may be formed in a gate in panel (GIP) type in the non-display area NA, but the present disclosure is not limited thereto.

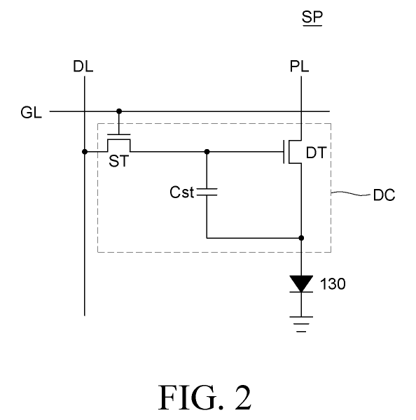

FIG. 2 is a circuit diagram of a subpixel of the stereoscopic image display device of FIG. 1.

Referring to FIG. 2, each subpixel SP may emit light representing a specific color according to a signal applied through signal lines GL, DL, and PL.

For example, a driving circuit DC which is electrically connected to the light emitting element 130 may be disposed in each subpixel SP. The driving circuit DC of each subpixel SP may control the light emitting element 130 of the corresponding subpixel SP according to a signal applied through the signal lines GL, DL, and PL. For example, the driving circuit DC of each subpixel SP may supply a driving current corresponding to the data signal to the light emitting element 130 of the corresponding subpixel SP according to the gate signal.

In some implementations , the driving current supplied by the driving circuit DC of each subpixel SP may be maintained for one frame. For example, the driving circuit DC of each subpixel SP may include a first thin film transistor ST, a second thin film transistor DT, and a storage capacitor Cst.

The first thin film transistor ST of each subpixel SP may transmit a data signal to the second thin film transistor DT of the corresponding subpixel SP according to a gate signal. The first thin film transistor ST of each subpixel SP may function as a switching thin film transistor. The first thin film transistor ST may include a first active layer, a first gate electrode, a first drain electrode, and a first source electrode. For example, the first gate electrode of each subpixel SP may be electrically connected to a corresponding gate line GL, and the first drain electrode of each subpixel SP may be electrically connected to a corresponding data line DL.

The second thin film transistor DT of each subpixel SP may generate a driving current corresponding to a data signal. That is, the second thin film transistor DT of each subpixel SP may function as a driving thin film transistor. The second thin film transistor DT may include a second active layer, a second gate electrode, a second drain electrode, and a second source electrode. For example, the second gate electrode of each subpixel SP may be electrically connected to the first source electrode of the corresponding subpixel SP, and the second drain electrode of each subpixel SP may be electrically connected to the corresponding power voltage supply line PL.

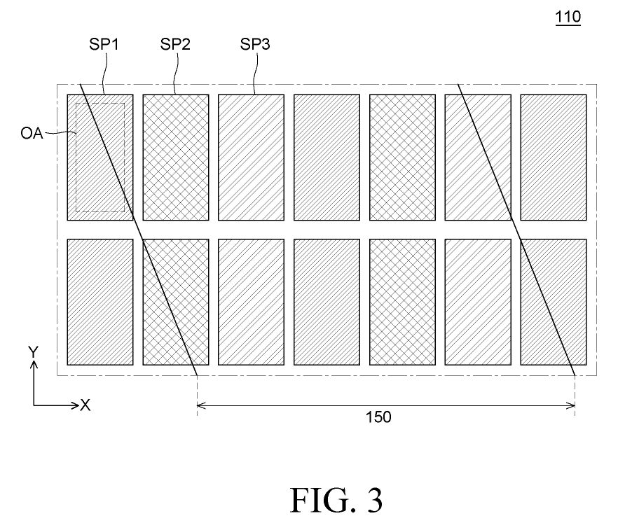

FIG. 3 is an enlarged view of part A of FIG. 1.

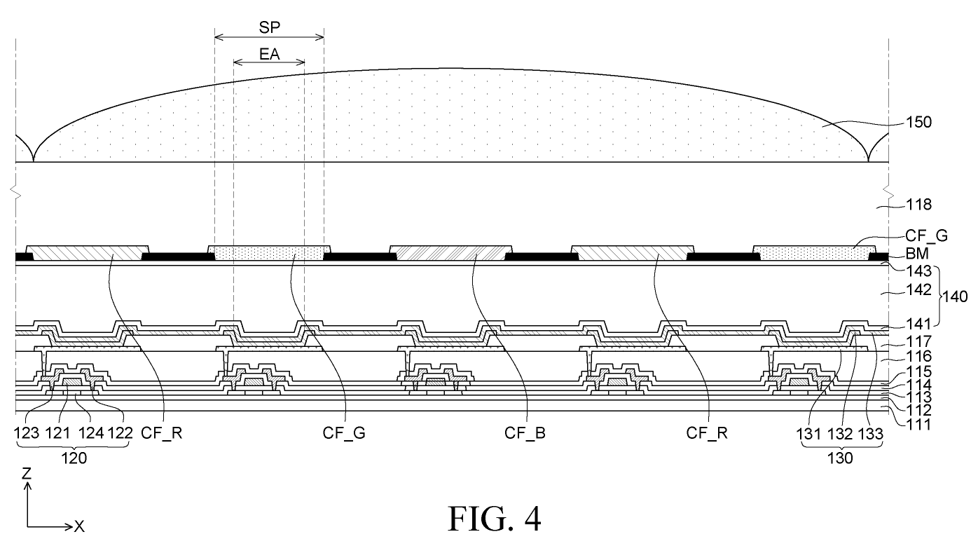

FIG. 4 is a view illustrating a cross-sectional structure of a part A of FIG. 1.

FIG. 3 illustrates a part of the display panel 110 in which fourteen subpixels SP1, SP2, and SP3 are disposed. Further, FIG. 4 illustrates a part of a cross-section of the display panel 110 in which the five subpixels SP1, SP2, and SP3 are disposed in one row as an example.

FIGS. 3 and 4 illustrate an example in which five subpixels SP1, SP2, SP3 and the like correspond to one optical lens 150, and one optical lens 150 can also correspond to two or more subpixels SP without being limited thereto. In a plan view of the display panel 110, the optical lens 150 covers or overlaps a plurality of sub-pixels in a manner inclined with respect to a row direction or a column direction of the plurality of sub-pixels. In some implementations, the optical lens 150 may be composed of one or more columnar (or semi-columnar) sub-lenses arranged side by side. In FIG. 4, the respective sub-lenses may be closely arranged in sequence to overlap the plurality of sub-pixels in the display panel.

Referring to FIGS. 3 and 4, the display panel 110 according to the example implementation of the present disclosure may include a pixel area in which the plurality of subpixels SP1, SP2, and SP3 is present and a line area in which various signal lines are disposed.

The plurality of first subpixels SP1, the second subpixels SP2, and the third subpixels SP3 may be disposed in the pixel area.

For example, the first subpixel SP1 may be a red subpixel.

For example, the second subpixel SP2 may be a green subpixel.

For example, the third subpixel SP3 may be a blue subpixel.

For example, the first subpixel SP1, the second subpixel SP2, and the third subpixel SP3 may have a polygonal shape, such as a rectangular shape, but are not limited thereto. The first subpixel SP1, the second subpixel SP2, and the third subpixel SP3 may have various shapes, such as a circular shape or an oval shape.

FIG. 3 illustrates a case where one first subpixel SP1, one second subpixel SP2, and one third subpixel SP3 are gathered to form one pixel, but the present disclosure is not limited thereto.

A driving transistor 120, a switching transistor, and a light emitting element 130 may be disposed over the substrate 111.The position of the driving transistor 120 may overlap, or may not overlap the light emitting element 130. In the implementation illustrated in FIG. 4, each driving transistor 120 controls one corresponding light emitting element 130, respectively. However, implementations of the present disclosure are not limited thereto.

For example, the substrate 111 may include a first substrate, a second substrate, and an interlayer insulating film. The interlayer insulating film may be disposed between the first substrate and the second substrate. In this way, the substrate 111 is composed of the first substrate, the second substrate, and the interlayer insulating film to prevent moisture penetration. For example, the first substrate and the second substrate may be polyimide (PI) substrates, but are not limited thereto. For example, the substrate may be made of a glass or plastic material, and may also be formed of, for example, one of polycarbonate, polyethersulfone (PES), polyarylate, polyethylene naphthalate (PEN), or polyethylene terephthalate (PET).

A plurality of transistors, such as the driving transistor 120 and the switching transistor, may be disposed over the substrate 111.

The driving transistor 120 may include an active layer 124, a gate electrode 121, a source electrode 122, and a drain electrode 123.

The buffer layer 112 may be disposed on the substrate 111.

The active layer 124 may be disposed on the buffer layer 112.

The gate insulating layer 113 may be disposed on the active layer 124.

Further, the gate electrode 121 may be disposed on the gate insulating layer 113.

An interlayer insulating layer 114 may be disposed on the gate electrode 121.

The source electrode 122 and the drain electrode 123 of the driving transistor 120 may be disposed on the interlayer insulating layer 114.

In this case, for example, the source electrode 122 and the drain electrode 123 may be electrically connected to a partial area of the active layer 124 through contact holes provided in the interlayer insulating layer 114 and the gate insulating layer 113.

A protection layer 115 may be disposed on the source electrode 122 and the drain electrode 123.

A planarization layer 116 may be disposed on the protection layer 115.

For example, the planarization layer 116 may include a first planarization layer and a second planarization layer, but is not limited thereto.

The planarization layer 116 may be made of an organic material, such as an acrylic resin or an epoxy resin, and for example, may be made of photo acryl (PAC), but is not limited thereto.

An anode 131 may be disposed on the planarization layer 116.

In one subpixel SP, the planarization layer 116 and the protection layer 115 may include a contact hole, and the drain electrode 123 of the driving transistor 120 and the anode 131 may be electrically connected through the contact hole.

A bank 117 may be disposed while covering a part of the anode 131. The bank 117 may cover a portion of an upper surface and side surfaces of the anode 131, and may protect the anode 131 while preventing current leakage or crosstalk while defining sub-pixels.

For example, a portion of the bank 117 corresponding to an emission area EA of the subpixel SP may be opened.

For example, the bank 117 may include an opening OA provided by removing (opening) a portion corresponding to the emission area EA of the subpixel SP.

For example, a part of the anode 131 may be exposed by the opening OA.

The bank 117 may be made of a PI-based material, but is not limited thereto.

For example, an organic layer 132 may be disposed around the opening OA of the bank 117. For example, the organic layer 132 may be disposed on the anode 131 exposed through the opening OA of the bank 117. For example, the organic layer 132 may be disposed in the opening OA of the bank 117.

The organic layer 132 may be disposed only in the opening OA, but the present disclosure is not limited thereto. A part of the organic layer 132 may also be disposed on a top surface and a side portion of the bank 117.

The organic layer 132 may have a multi-layered structure, and the organic layer 132 may include at least one emission layer (EML). The emission layer may include an organic light emitting material, an inorganic light emitting material, or a hybrid light emitting material. Further, for example, the organic layer 132 may further include at least one of a hole injection layer (HIL), a hole transport layer (HTL), an electron transport layer (ETL), and an electron injection layer (EIL). Accordingly, the luminous efficiency of the emission layer may be improved.

A cathode 133 may be disposed on the organic layer 132, and the cathode 133 may include a conductive material. The light emitting element 130 may include the anode 131, the organic layer 132, and the cathode 133.

The cathode 133 may include a material different from that of the anode 131. The transmittance of the cathode 133 may be higher than that of the anode 131. For example, the cathode 133 may be a transparent electrode made of a transparent conductive material such as ITO and IZO. Accordingly, in the stereoscopic image display device according to an implementation of the present disclosure, light generated by the emission layer may be emitted through the cathode 133. The cathode 133 may cover a surface of the entire pixel area in a continuous manner, or may be appropriately patterned. The cathode 133 may also have an uneven shape according to variations of the bank and the opening.

In this case, an image implemented by light emitted from the light emitting element 130 of each subpixel SP may include various colors. Light emitted from the light emitting element 130 of each subpixel SP may have a different color from light emitted from the light emitting element 130 of an adjacent subpixel SP. For example, the emission area EA of each subpixel SP may be one of a red emission area in which red light is emitted, a green emission area in which green light is emitted, and a blue emission area in which blue light is emitted. The emission layer of the organic layer 132 of each subpixel SP may be spaced apart from the emission layer of the adjacent subpixel SP. For example, the emission layer of each subpixel SP may be one of the red emission layer that generates red light, the green emission layer that generates green light, and the blue emission layer that generates blue light. The organic layer 132 of each subpixel SP may include a material different from that of the organic layer 132 of the adjacent subpixel SP. Further, for example, the organic layer 132 of each subpixel SP may have a stacked structure different from that of the organic layer 132 of an adjacent subpixel SP. The organic layer 132 of each subpixel SP may include an end portion positioned on the bank 117.

An encapsulation layer 140 may be disposed over the light emitting element 130.

The encapsulation layer 140 may prevent damage to the light emitting element 130 disposed in each subpixel SP due to external impact and moisture.

In this case, the encapsulation layer 140 may have a multi-layered structure. For example, the encapsulation layer 140 may include a first encapsulation layer 141, a second encapsulation layer 142, and a third encapsulation layer 143 sequentially stacked. The first encapsulation layer 141, the second encapsulation layer 142, and the third encapsulation layer 143 may include an insulating material. The second encapsulation layer 142 may include a material different from those of the first encapsulation layer 141 and the third encapsulation layer 143. For example, the first encapsulation layer 141 and the third encapsulation layer 143 may include an inorganic insulating material, and the second encapsulation layer 142 may include an organic insulating material. Accordingly, in the stereoscopic image display device according to an implementation of the present disclosure, damage to the light emitting element 130 due to external impact and moisture may be effectively prevented. The step difference due to the light emitting element 130 of each subpixel SP may be removed by the second encapsulation layer 142. The second encapsulation layer 142 may have a greater thickness than the first encapsulation layer 141 and the third encapsulation layer 143. For example, a top surface of the encapsulation layer 140 facing the substrate 111 may be a flat plane. The top surface of the encapsulation layer 140 may be parallel to a top surface of the substrate 111.

Color filters CF_R, CF_G, and CF_B may be disposed over the encapsulation layer 140.

Each of the color filters CF_R, CF_G, and CF_B may overlap the emission area EA of each subpixel SP. For example, the color filters CF_R, CF_G, and CF_B may include a red color filter CF_R overlapping the red emission area, a green color filter CF_G overlapping the green emission area, and a blue color filter CF_B overlapping the blue emission area. Light generated by the light emitting element 130 of each subpixel SP may be emitted to the outside through the color filters CF_R, CF_G, and CF_B of the corresponding subpixel SP. Accordingly, in the stereoscopic image display device according to an implementation of the present disclosure, a color reproduction rate may be improved. However, the present disclosure is not limited thereto.

The color filters CF_R, CF_G, and CF_B of each subpixel SP may have a larger size than the emission area EA of the corresponding subpixel SP. For example, the color filters CF_R, CF_G, and CF_B of each subpixel SP may include an area located outside the emission area EA defined in the corresponding subpixel SP. In this case, the area positioned between the adjacent emission areas EA may be defined as a non-emission area. For example, ends of the color filters CF_R, CF_G, and CF_B positioned on each subpixel SP may overlap the non-emission area. Accordingly, in the stereoscopic image display device according to the example implementation of the present disclosure, the amount of light emitted to the outside through the color filters CF_R, CF_G, and CF_B of each subpixel SP may be further increased. Therefore, the light extraction efficiency may be increased.

A barrier layer BM may be disposed on the non-emission area of the encapsulation layer 140. For example, the barrier layer BM may overlap the bank 117. For example, the barrier layer BM may be disposed side by side with the color filters CF_R, CF_G, and CF_B. Further, for example, the color filters CF_R, CF_G, and CF_B and the barrier layer BM may be in direct contact with the third encapsulation layer 143. Ends of the color filters CF_R, CF_G, and CF_B may partially overlap the barrier layer BM. For example, the barrier layer BM may include an area positioned between the third encapsulation layer 143 and ends of each of the color filters CF_R, CF_G, and CF_B.

The barrier layer BM may include a material capable of blocking light. For example, the barrier layer BM may include a black dye such as carbon black. Accordingly, in the stereoscopic image display device according to the example implementation of the present disclosure, light emitted from the light emitting element 130 of each subpixel SP toward the color filters CF_R, CF_G, and CF_B of adjacent subpixels SP may be blocked by the barrier layer BM. Accordingly, in the stereoscopic image display device according to the example implementation of the present disclosure, light leakage due to light emission which does not pass through the color filters CF_R, CF_G, and CF_B of each subpixel SP may be prevented. In addition, in the stereoscopic image display device according to an implementation of the present disclosure, unintended mixing of light may be prevented. Furthermore, the barrier layer BM may be disposed to overlap with the bank 117 in a cross-sectional view, thereby improving an aperture ratio and ensuring luminous efficiency of the light-emitting element 130.

An optical insulating layer 118 may be disposed on the color filters CF_R, CF_G, and CF_B and the barrier layer BM. The optical insulating layer 118 may prevent damage to the color filters CF_R, CF_G, and CF_B and the barrier layer BM due to external moisture and impact.

For example, the optical insulating layer 118 may be formed of an insulating material. Further, the optical insulating layer 118 may be formed of a transparent insulating material.

For example, the optical insulating layer 118 may include an inorganic insulating material and/or an organic insulating material. A step difference due to the color filters CF_R, CF_G, and CF_B and the barrier layer BM may be removed by the optical insulating layer 118. In other words, the optical insulating layer 118 may also function as another planarization layer.

For example, a top surface of the optical insulating layer 118 facing the encapsulation layer 140 may be flat. The top surface of the optical insulating layer 118 may be parallel to a top surface of the encapsulation layer 140.

An optical lens 150 may be disposed on the optical insulating layer 118.

As described above, the stereoscopic image display device of the present disclosure may include a display panel 110 which outputs a 2D image, and an optical lens 150 which is disposed above the display panel 110 to optically separate the 2D image and provide the 3D image.

In some implementations, for example, the display panel 110 may sequentially allocate and output stereoscopic view data from a first view to an mth view to each of m subpixels (where m is a natural number). The optical lens 150 is disposed on a front surface of the display panel 110 to separate the optical axis of the output view data to form a left-eye image (L-view image) and a right-eye image (R-view image) at a viewing distance.

The optical lens 150 may be disposed side by side along the upper surface of the optical insulating layer 118. The optical lens 150 may extend parallel to one direction. For example, in the stereoscopic image display device according to an example implementation of the present disclosure, the subpixels SP may be positioned side by side in the first direction X and the second direction Y perpendicular to the first direction X, and each optical lens 150 may extend in a direction inclined with respect to the first direction X and the second direction Y. In some implementations, each optical lens 150 may be a lenticular lens having a slanted structure that is obliquely disposed at an angle with respect to the subpixels SP in a plan view of the image display device, as shown in the example of FIG. 3.

An image caused by light emitted from the light emitting element 130 of each subpixel SP may be three-dimensionally recognized by a viewer by the optical lens 150. The optical lens 150 may be a lenticular lens. For example, the stereoscopic image display device according to an implementation of the present disclosure may be a light-field display device (LFD) that provides a stereoscopic image to a viewer in a light field manner using an optical lens 150. That is, the light field display device may provide a binocular parallax image using the 2D display panel 110 and a light separation element such as a lenticular lens to enable 3D viewing. In general, the light field display device may be designed to have a fixed rear distance and implement a minimum crosstalk at a specific distance (e.g., an optimal viewing distance OVD). Accordingly, when a viewer views an image at a position spaced forward or backward from the designed optimal viewing distance OVD, a mismatch occurs in the optical path of the image projected into the left eye and the right eye, thereby increasing 3D crosstalk and reducing the quality of the stereoscopic image. Further, when the viewing direction is changed from a front direction to a diagonal direction due to a change in the position of the user or when side areas of the display device are viewed from a position other than a center position, optical separation accuracy is degraded due to the aberration of the lens (e.g., a lenticular lens). Therefore, the interference of the stereoscopic image is increased, thereby intensifying the crosstalk.

For example, each optical lens 150 may overlap the plurality of subpixels SP in the first direction X. The optical lens 150 may be formed by a reflow process, but is not limited thereto.

For example, five subpixels SP may overlap one of the plurality of optical lenses 150, but are not limited thereto. In this case, one optical lens 150 positioned above the five subpixels SP may have a size larger than the total size of five emission areas EA disposed in the five subpixels SP.

The stereoscopic image display device 100 according to an implementation of the present disclosure configured as described above adjusts a grayscale value of 3D input data of some subpixels in units of subpixels based on the location information of the viewer, thereby effectively reducing crosstalk, which will be described in detail with reference to the accompanying drawings.

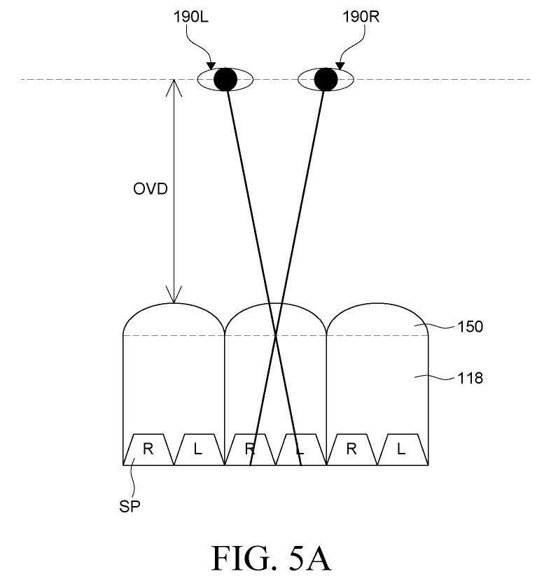

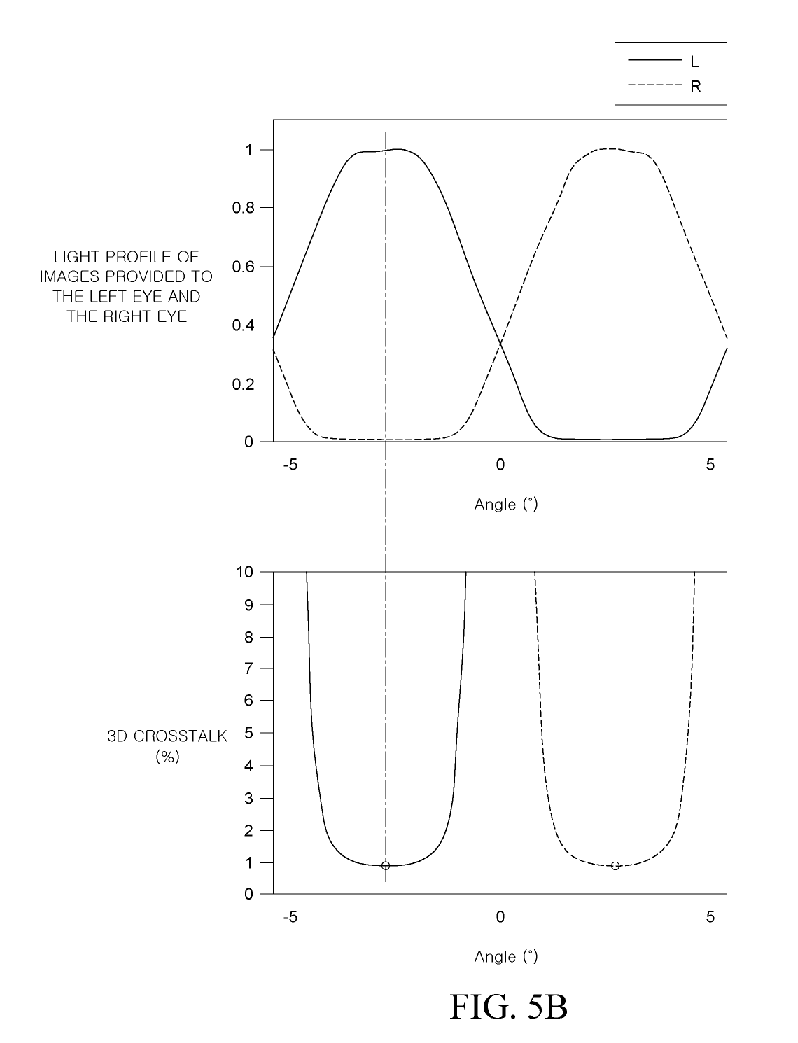

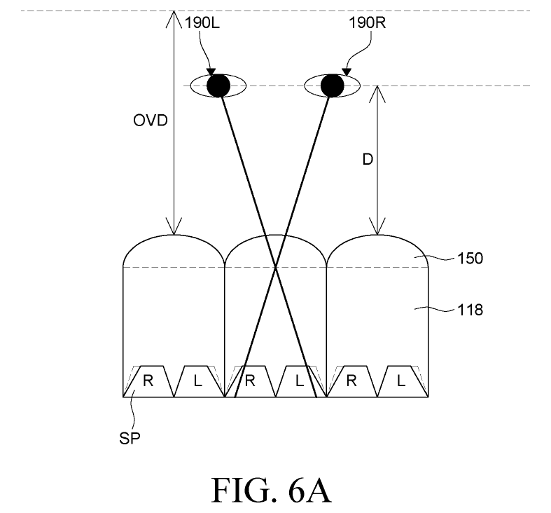

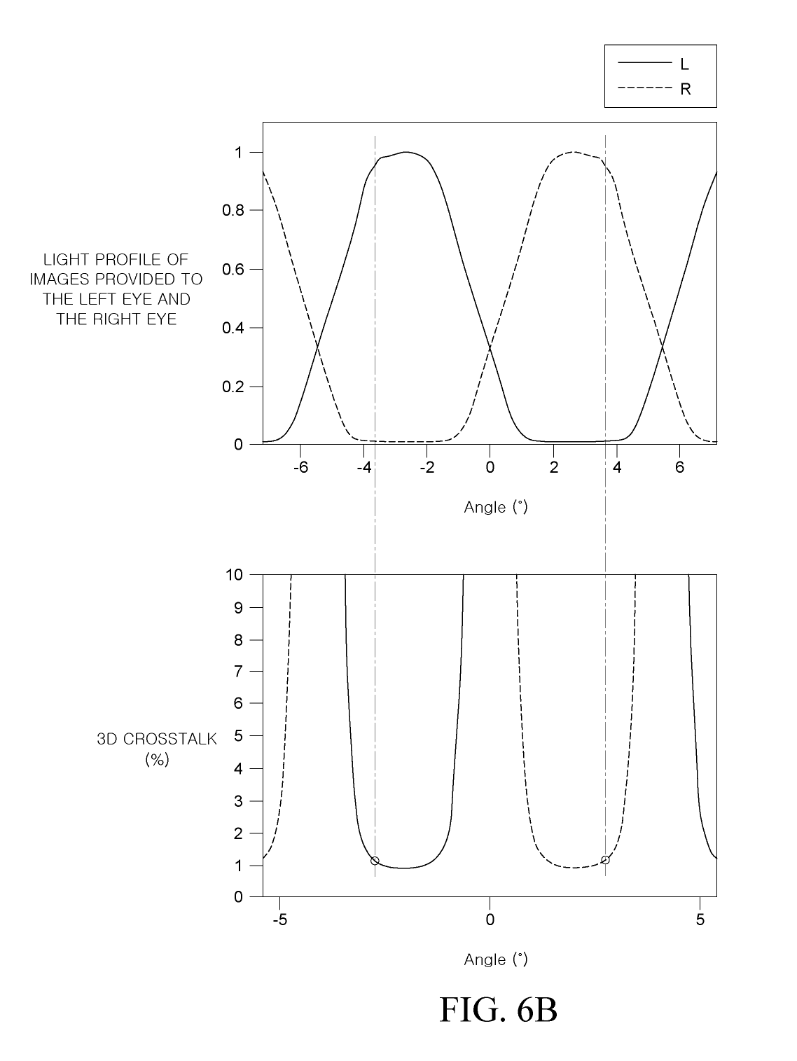

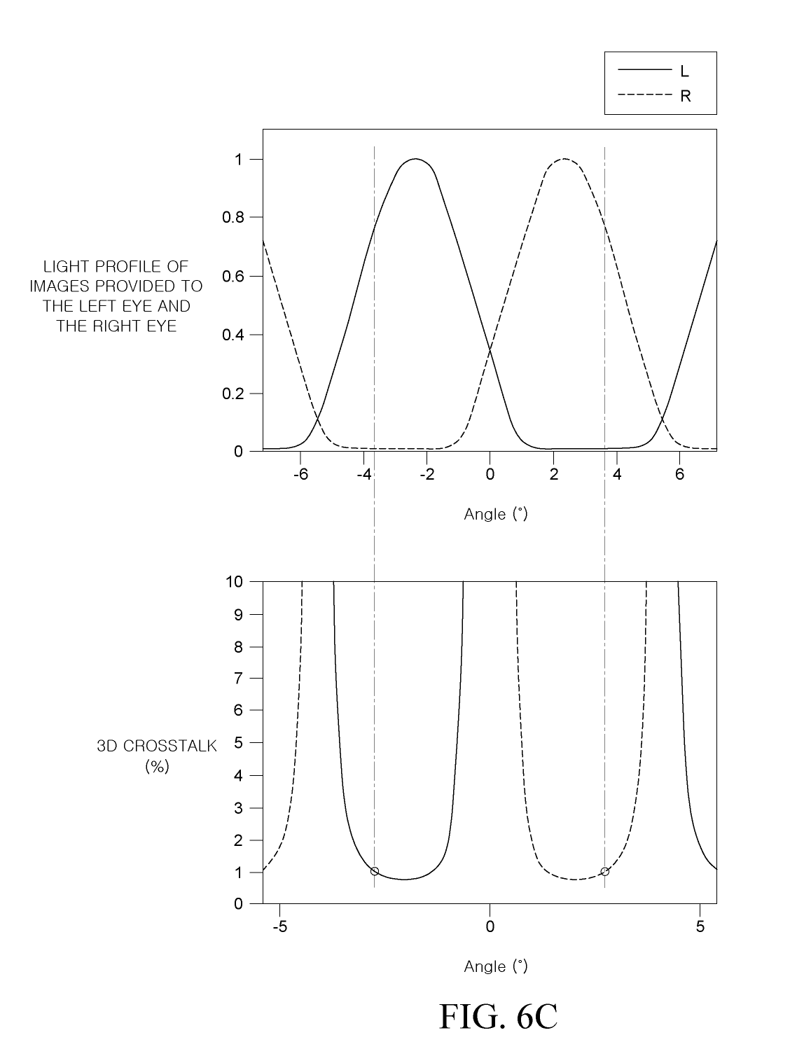

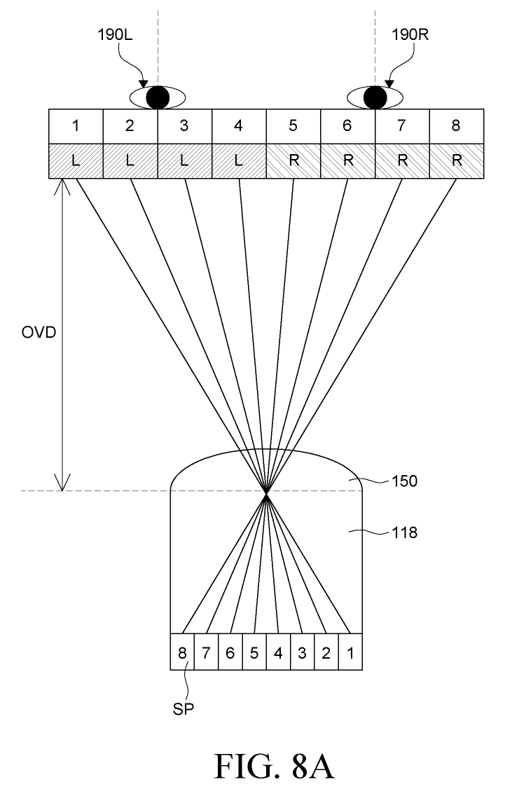

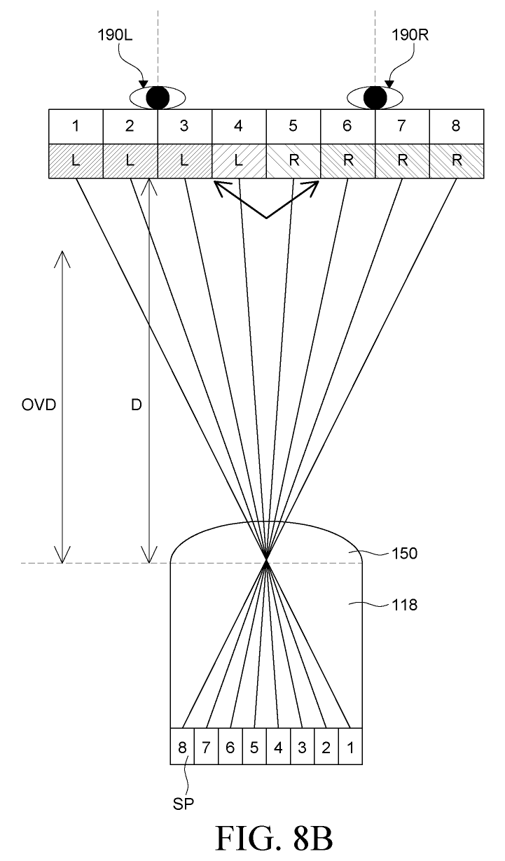

First, a method of optimizing crosstalk according to a viewing distance will be described in detail with reference to FIGS. 5A - 5B, FIGS. 6A -6C, FIGS, 7A-7C, and FIGS. 8A-8B..

FIG. 5A is a diagram schematically illustrating a state in which a stereoscopic image is viewed through a stereoscopic image display device according to an implementation of the present disclosure at an optimal viewing distance (OVD).

FIG. 5B is a graph illustrating light profiles and crosstalk of images provided to a left eye and a right eye in the stereoscopic image display device of FIG. 5A.

FIG. 6A is a diagram schematically illustrating a state in which a stereoscopic image is viewed through stereoscopic image display device according to an implementation of the present disclosure at a distance closer than the OVD.

FIGS. 6B and 6C are graphs showing light profiles and crosstalk of images provided to a left eye and a right eye in the stereoscopic image display device of FIG. 6A.

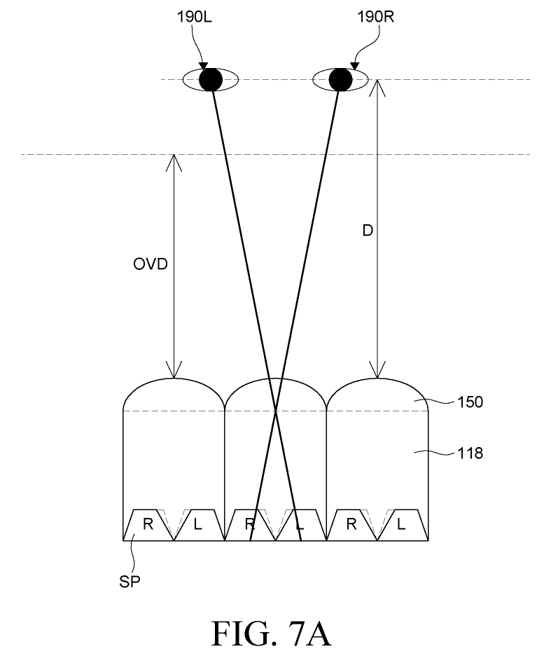

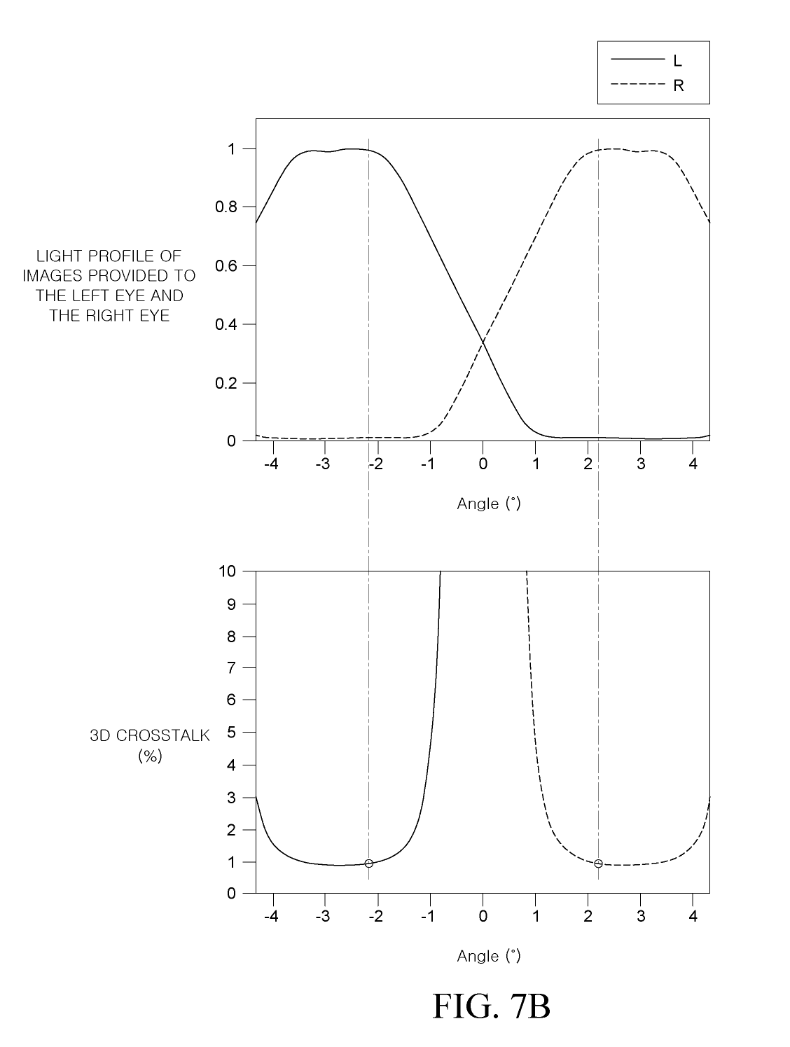

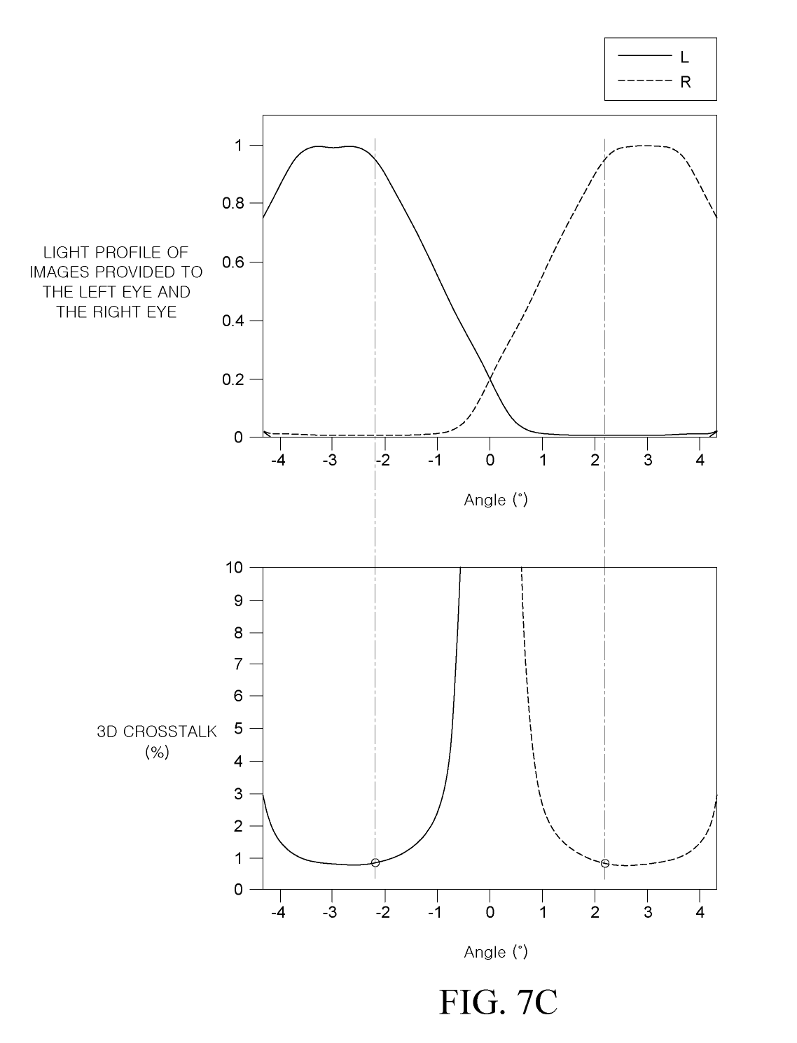

FIG. 7A is a diagram schematically illustrating a state in which a stereoscopic image is viewed through stereoscopic image display device according to an implementation of the present disclosure at a distance farther than the OVD.

FIGS. 7B and 7C are graphs showing an light profile and a crosstalk of an image provided to a left eye and a right eye in the stereoscopic image display device of FIG. 7A.

In the upper graphs of FIGS. 5B, 6B, 6C, 7B, and 7C, L represents a light profile of an image recognized in the left eye, and R represents a light profile of an image recognized in the right eye. In addition, in the lower graphs of FIGS. 5B, 6B, 6C, 7B, and 7C, L represents the crosstalk of the image recognized in the left eye, and R represents the crosstalk of the image recognized in the right eye.

Since the existing light field display device has a fixed rear distance, it exhibits optimal 3D crosstalk characteristics only at a specific distance, that is, an optimal viewing distance (OVD). In addition, 3D can be viewed within a certain range through eye-tracking-based image processing, but 3D crosstalk inevitably increases as it goes beyond OVD.

To solve this problem, the present disclosure is characterized in that the grayscale value of 3D input data is changed in units of a subpixel according to the position of the viewer.

Referring to FIG. 5A, a lenticular lens type stereoscopic image display device may include a display panel and an optical lens 150 located on a front surface of the display panel to implement a stereoscopic image.

For example, the optical lens 150 may be a lenticular lens whose upper surface is formed of a convex lens-shaped material layer on a flat substrate.

The optical lens 150 serves to divide the left and right eye images, and at an optimal viewing distance OVD from the optical lens 150, a diamond-shaped viewing diamond (constant area) in which images corresponding to the left eye 190L and the right eye 190R reach normally to the left eye 190L and the right eye 190R, respectively, may be formed.

In the case of the optimal viewing distance OVD, the left eye 190L and the right eye 190R may view the center of images corresponding to the left eye 190L and the right eye 190R, respectively.

Width of one viewing diamond is formed to have a size corresponding to a viewer's binocular spacing (e), so that images having parallax are respectively provided to the left eye 190L and right eye 190R of the viewer to be perceived as a stereoscopic image.

In this case, view data of a subpixel SP of the display panel corresponding to each viewing diamond, that is, an image, may be formed in each viewing diamond.

The view data may refer to image data captured by cameras spaced apart from each other by a distance corresponding to a binocular spacing (e).

For example, in the case of eight views, the viewing diamond is sequentially applied with a first view to an eighth view, respectively, and a second view relative to the first view is located on the right or left side and may be directional. The viewing diamond may be repeatedly formed by reflecting corresponding view data.

Referring to FIG. 5B, looking at the light profile measured at the optimal viewing distance OVD, it may be seen that the intensity of light is the highest in the left and right eye positions (indicated by dashed lines in FIG. 5B) and the intensity of light gradually decreases as it deviates from the binocular position. In addition, looking at the 3D crosstalk measured at the optimal viewing distance OVD, it may be seen that the 3D crosstalk is minimum in the binocular position, and the 3D crosstalk increases as the distance from the binocular position increases.

The size and width of the light profile of each view are affected by the display panel, the optical lens 150, the light source, and the like. At the optimal viewing distance OVD, it can be seen that both eyes are located at the lowest point in the crosstalk graph.

In some implementations, the size of the overlapping area between the light profile of the view corresponding to the adjacent viewing diamond and the light profile of the view of the current viewing position may contribute to 3D crosstalk. When the 3D crosstalk increases, the 3D depth perceived by the viewer also deteriorates, and the image may be blurred.

That is, in the ideal case, only the information of the corresponding view is visible in the left and right eyes (for example, only L-view can be seen in the left eye and R-view cannot be seen in the left eye), but R-view can also be seen faintly in addition to L-view in the left eye, resulting in 3D crosstalk.

In some implementations, referring to FIGS. 6A and 6B, when a viewer watches at a distance D closer than the optimal viewing distance OVD, the left eye 190L and the right eye 190R see the outside of images corresponding to the left eye 190L and the right eye 190R, respectively. Accordingly, images transferred from the stereoscopic image display device to the left eye 190L and the right eye 190R overlap with each other, thereby increasing 3D crosstalk. That is, it may be seen that the positions of the left eye and the right eye (indicated by dashed lines in FIG. 6B) are separated outward from the area having the highest light intensity. This is because when the viewer watches at a distance D closer than the optimal viewing distance OVD, the parallax of the left and right images becomes excessively large, and the images transmitted to the left eye 190L and the right eye 190R partially overlap. As a result, overlapping of the left and right images occurs, and 3D crosstalk increases. That is, when looking at the 3D crosstalk measured at a distance D closer than the optimal viewing distance OVD, it may be seen that the positions of the left and right eyes move outward from the lowest point of the crosstalk graph, and accordingly, it may be seen that the 3D crosstalk in both eyes increases.

To solve this problem, an example implementation of the present disclosure adopts a method of adjusting a grayscale value in units of subpixels SP, referring to FIGS. 6A and 6C. Specifically, when the viewer watches at a distance D closer than the optimal viewing distance OVD, a method of lowering the grayscale value of the left and right (RL) outer subpixels SP (indicated by dashed lines in FIG. 6A) is adopted to overlap the left and right images. It can alleviate the problem and reduce 3D crosstalk. That is, when the method of lowering the grayscale value of the left and right (RL) outer subpixels SP is applied, the overall level of the crosstalk graph decreases and the slope becomes gentle, and accordingly, it may be seen that the 3D crosstalk effectively decreases. Accordingly, it is possible to minimize the distortion of the image according to the position of the viewer and solve the crosstalk problem. For example, when a viewer watches at a distance D that is 0.75 times closer than the optimal viewing distance OVD, it may be seen that the crosstalk is 1.15% before applying the grayscale value adjustment method, whereas the crosstalk is reduced to 1.02% after applying the grayscale value adjustment method.

In addition, in some implementations of the present disclosure, the number of left and right (RL) outer subpixels SP which lowers the grayscale value of the subpixels SP may be dynamically adjusted according to the difference between the viewer's actual viewing distance and the optimal viewing distance OVD.

As the difference between the actual viewing distance and the optimal viewing distance OVD increases, the range of lowering the grayscale value of the left and right (RL) outer subpixels SP is also expanded, so that the grayscale value of more subpixels SP is lowered, and crosstalk can be more effectively prevented. On the other hand, when the actual viewing distance is close to the optimal viewing distance OVD, the number of subpixels SP that lowers the grayscale value is relatively small, minimizes image distortion, and maintains the optimal 3D effect. Here, the left and right (RL) outer subpixels SP mean subpixels SP located outside each of the plurality of left and right (RL) subpixels SP forming one L-view and R-view.

Further, referring to FIGS. 7A and 7B, when a viewer views at a distance D farther than the optimal viewing distance OVD, the left eye 190L and the right eye 190R see the inside of images corresponding to the left eye 190L and the right eye 190R, respectively. Accordingly, in the stereoscopic image display device, the parallax of the image transmitted to the left eye 190L and the right eye 190R is relatively small, which may cause 3D crosstalk. This is because the parallax between the left and right images is not sufficiently matched when the viewer watches at a distance D farther than the optimal viewing distance OVD. That is, it may be seen that the positions of the left eye and the right eye (indicated by dashed lines in FIG. 7B) are separated inward from the area having the highest light intensity. In addition, looking at the 3D crosstalk measured at a distance D farther than the optimal viewing distance OVD, it may be seen that the positions of the left and right eyes have moved inward from the lowest point of the crosstalk graph, and accordingly, it may be seen that the 3D crosstalk in both eyes increases.

To solve this problem, according to an implementation of the present disclosure, referring to FIGS. 7A and 7C, a method of adjusting a grayscale value in units of subpixels SP is adopted. Specifically, when the viewer watches at a distance D farther than the optimal viewing distance OVD, a method of lowering the grayscale value of the left and right (RL) inner subpixels SP (see the dotted line in FIG. 7A) is adopted to reduce the 3D crosstalk. That is, when the method of lowering the grayscale value of the left and right (RL) inner subpixels SP is applied, the overall level of the crosstalk graph decreases and the slope becomes gentle, and accordingly, it may be seen that the 3D crosstalk effectively decreases. Accordingly, it is possible to minimize the distortion of the image according to the position of the viewer and solve the crosstalk problem. For example, when a viewer watches at a distance D 1.25 times farther than the optimal viewing distance OVD, it may be seen that the crosstalk is 0.94% before applying the grayscale value adjustment method, whereas the crosstalk is reduced to 0.83% after applying the grayscale value adjustment method.

Further, in some implementations of the present disclosure, the number of the left and right inner subpixels SP which lowers the grayscale value of the subpixels SP may be dynamically adjusted according to the difference between the actual viewing distance and the optimal viewing distance OVD of the viewer.

As the difference between the actual viewing distance and the optimal viewing distance OVD increases, the range of lowering the grayscale value of the left and right inner subpixels SP is also expanded, so that the grayscale value of more subpixels SP is lowered, and crosstalk can be more effectively prevented. On the other hand, when the actual viewing distance is close to the optimal viewing distance OVD, the number of subpixels SP that lowers the grayscale value is relatively small, minimizes image distortion, and maintains the optimal 3D effect. Here, the left and right (RL) inner subpixels SP mean subpixels SP located inside each of the plurality of left and right (RL) subpixels SP forming one L-view and R-view.

Hereinafter, an example in which the method of changing the subpixel grayscale value of the present disclosure is applied to 3D crosstalk optimization according to the viewing distance in a case in which four subpixels form one L-view and one R-view is described with reference to the drawings.

FIG. 8A is a diagram schematically illustrating a method of implementing a stereoscopic image display device in an OVD.

FIG. 8B is a diagram schematically illustrating a method of implementing a stereoscopic image display device by applying grayscale value adjustment of the present disclosure at a distance farther than an OVD.

In FIGS. 8A and 8B, L represents a subpixel SP forming an L-view, and "R" represents a subpixel SP forming an R-view. In this case, the subpixels SP are actually disposed under the optical lens 150, but are provided to the left eye 190L and the right eye 190R, respectively, to visually correspond to the subpixels SP forming the left and right images, which are exemplarily illustrated on the drawing.

Referring to FIG. 8A, each subpixel SP at an optimal viewing distance OVD is configured to output an image corresponding to any one of the left eye 190L and the right eye 190R. For example, subpixels SP No. 1 to No. 4 form an image provided to the left eye 190L, that is, L-view, and subpixels SP No. 5 to No. 8 form an image provided to the right eye 190R, that is, R-view.

The optical lens 150 refracts light emitted from the subpixel SP to make it travel in a specific viewing direction, and accordingly, light emitted from the subpixel SP corresponding to the L-view is guided in the left eye 190L direction, and light emitted from the subpixel SP corresponding to the R-view is guided in the right eye 190R direction. Through this configuration, the viewer receives different images through the left eye 190L and the right eye 190R, and accordingly, a stereoscopic image may be implemented.

Referring to FIG. 8B, when a viewer views an image at a distance D farther than an optimal viewing distance OVD, even though each subpixel SP outputs an image corresponding to the left eye 190L or the right eye 190R, as illustrated in FIG. 8A, the quality of the stereoscopic image may deteriorate. This is because, as the eye position of the viewer becomes farther than the viewing separation point designed at the optimal viewing distance OVD, the position at which the light refracted and output through the optical lens 150 reaches the actual left eye 190L and the right eye 190R changes, so that the L-view light to be transmitted to the left eye 190L partially flows into the right eye 190R or vice versa. As a result, a crosstalk phenomenon occurs in which the left and right images are not accurately separated and interfere with each other.

In order to solve this problem, in FIG. 8B, a method of adjusting a grayscale value in units of subpixels SP is adopted. Specifically, among the subpixels SP corresponding to the left eye 190L and the right eye 190R, the parallax mismatch occurring at the overlapping portion of the binocular image may be mitigated by reducing the grayscale value of the inner subpixels SP located at the boundary, for example, the fourth subpixel SP corresponding to the L-view indicated by the arrow in FIG. 8B and the fifth subpixel SP corresponding to the R-view.

Such grayscale value adjustment is performed by fine luminance control in units of a subpixel SP, whereby a clear separation between left and right images is possible, and as a result, 3D crosstalk is reduced. Furthermore, this configuration may flexibly respond to a change in the position of a viewer, thereby providing a stable stereoscopic image even at positions other than the optimal viewing distance OVD.

In addition, the grayscale value adjustment method may operate based on real-time location information of a viewer. For example, the position coordinates (X, Y, Z) of the viewer are collected using the gaze tracking technique, and based on this, the inter-eye separation mapping interval between the positions reached after the left eyes 190L and right eyes 190R pass through the optical lens 150 may be calculated. When the calculated inter-eye separation mapping interval is different from the reference interval at the optimal viewing distance OVD, the image quality may be optimized by determining the subpixel SP whose crosstalk is caused by the interval difference and selectively adjusting the grayscale value of the subpixel SP corresponding thereto.

In this case, the crosstalk may be reduced by gradually reducing the grayscale value of the corresponding subpixel by calculating the area of the subpixel that affects the crosstalk.

This method may be applied in a direction to relatively reduce the light output of the last subpixel (e.g., the fourth subpixel SP) of the L-view and the first subpixel (e.g., the fifth subpixel SP) of the R-view, in consideration of the high possibility of crosstalk in the subpixel SP located at the left and right viewing boundaries. As a result, this grayscale value adjustment technique of the present disclosure supports viewers to stably enjoy a clear stereoscopic image without distortion even in various viewing environments.

In some implementations, the luminance reduced while optimizing the 3D crosstalk may be compensated for by partially increasing the luminance of the subpixel SP or the backlight unit.

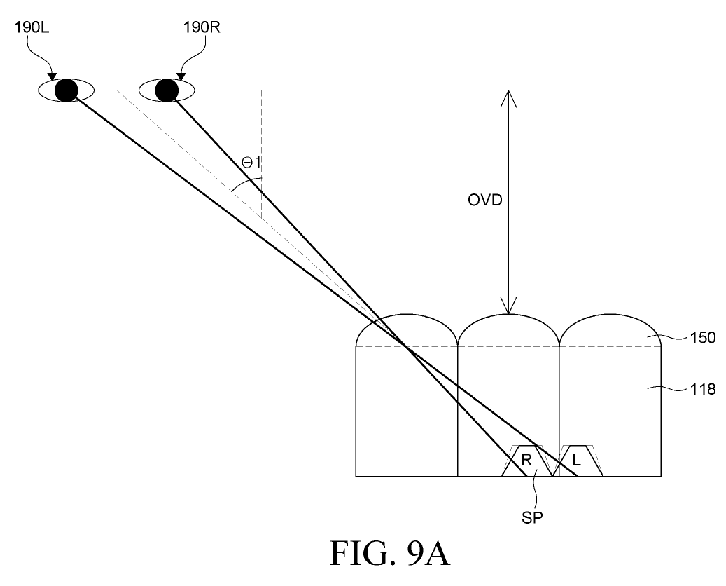

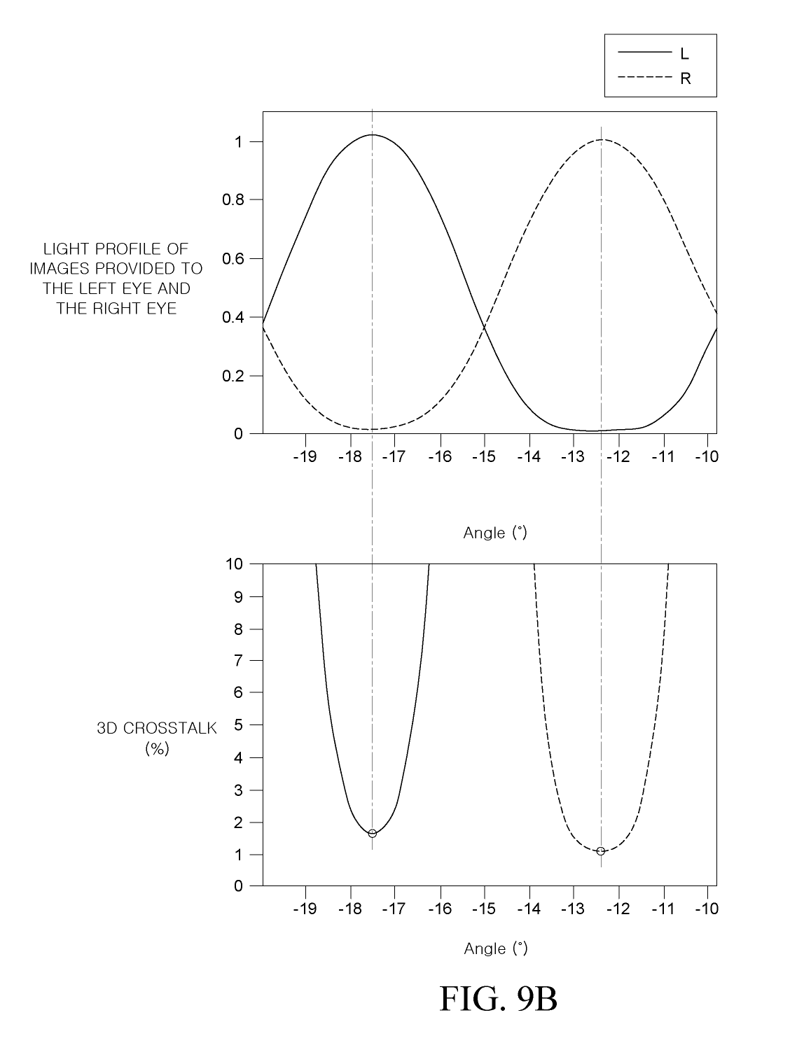

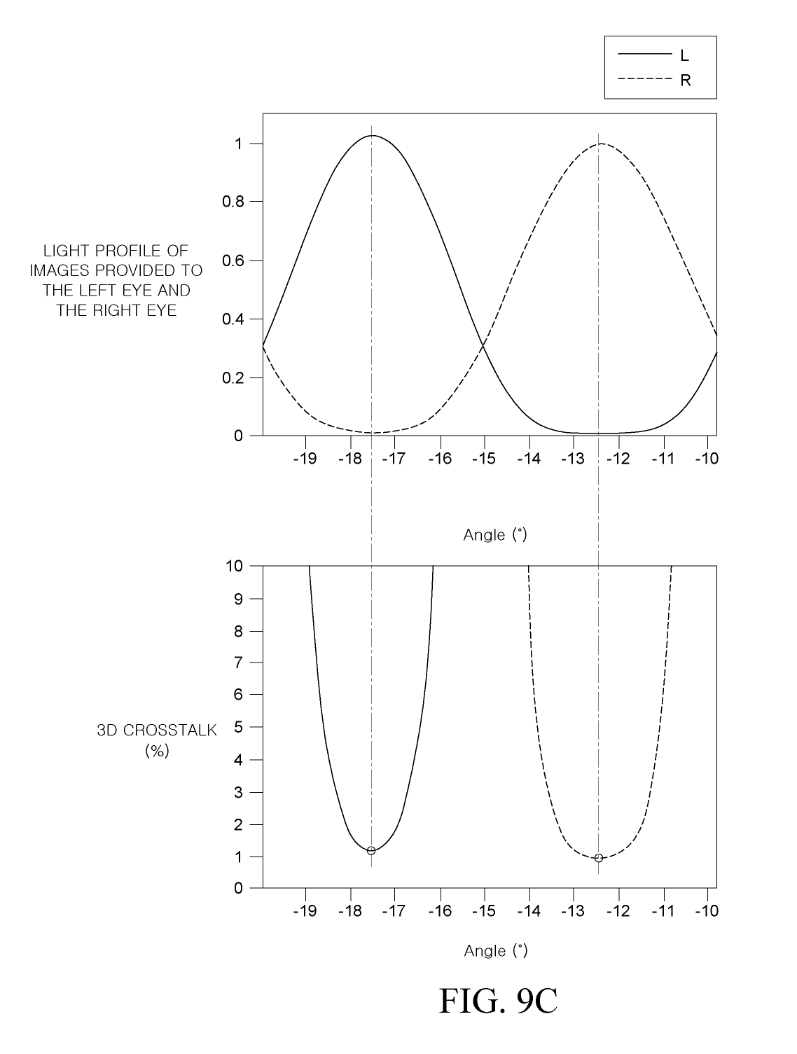

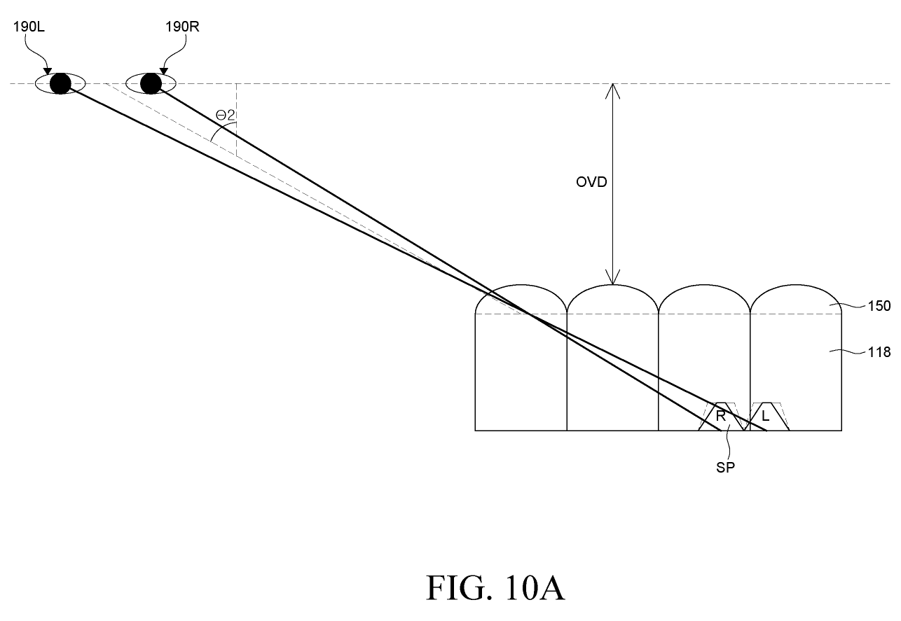

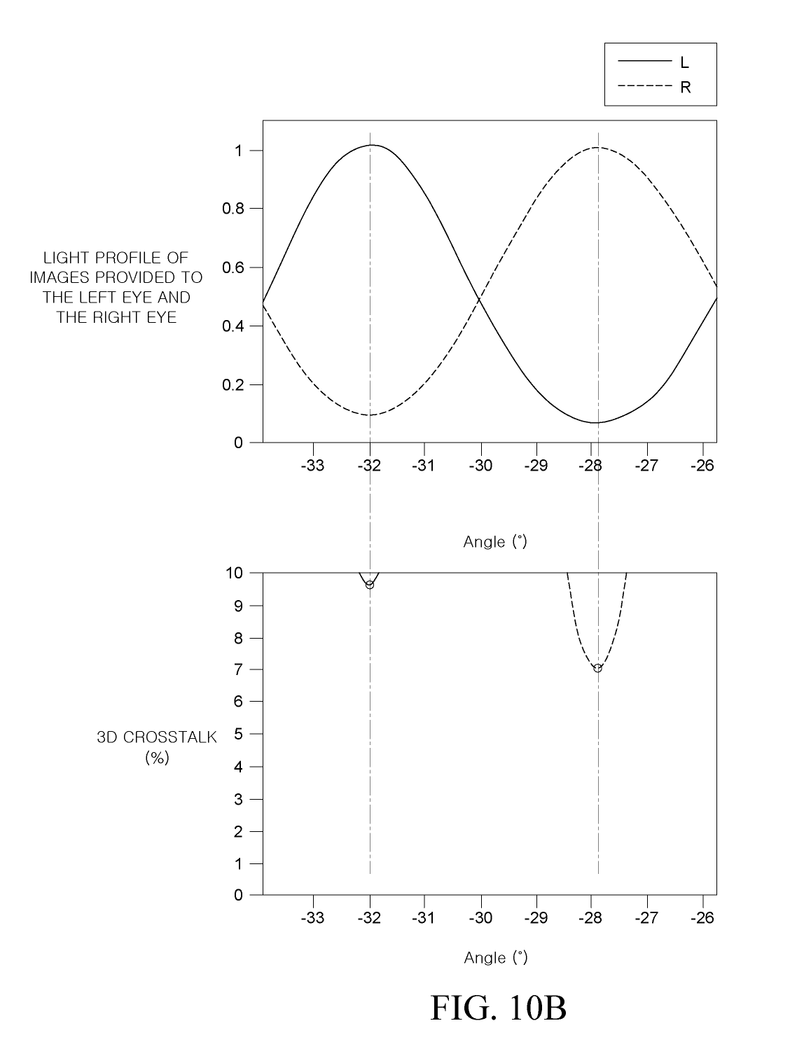

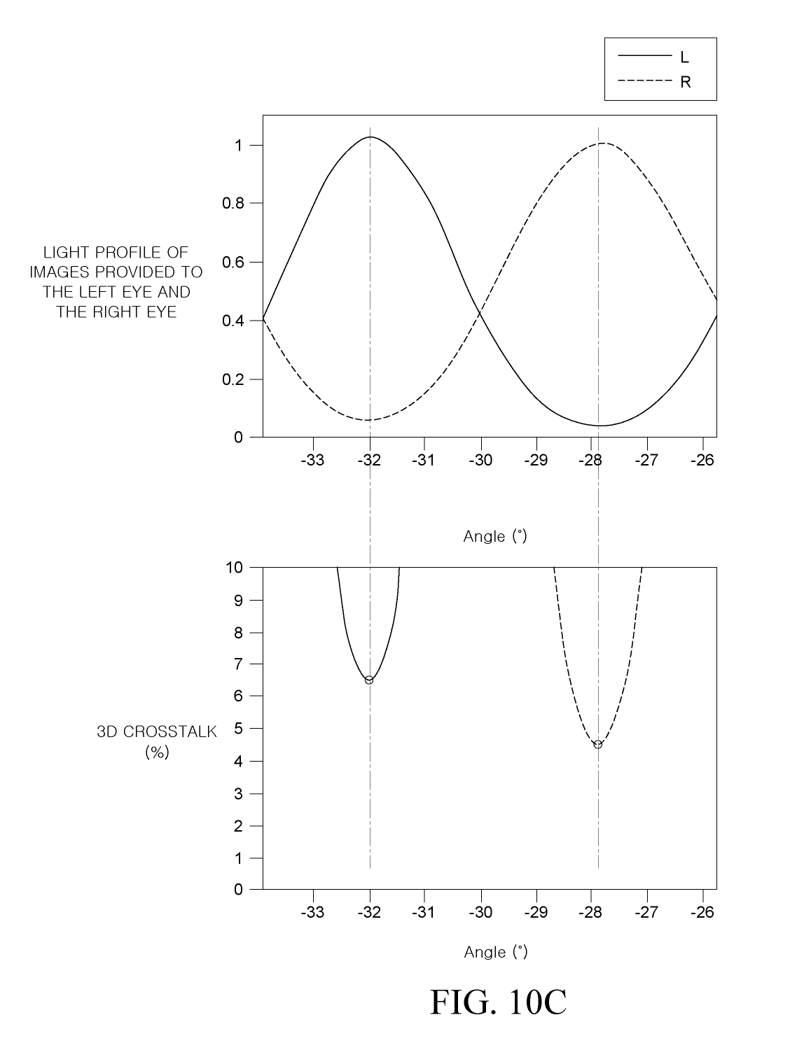

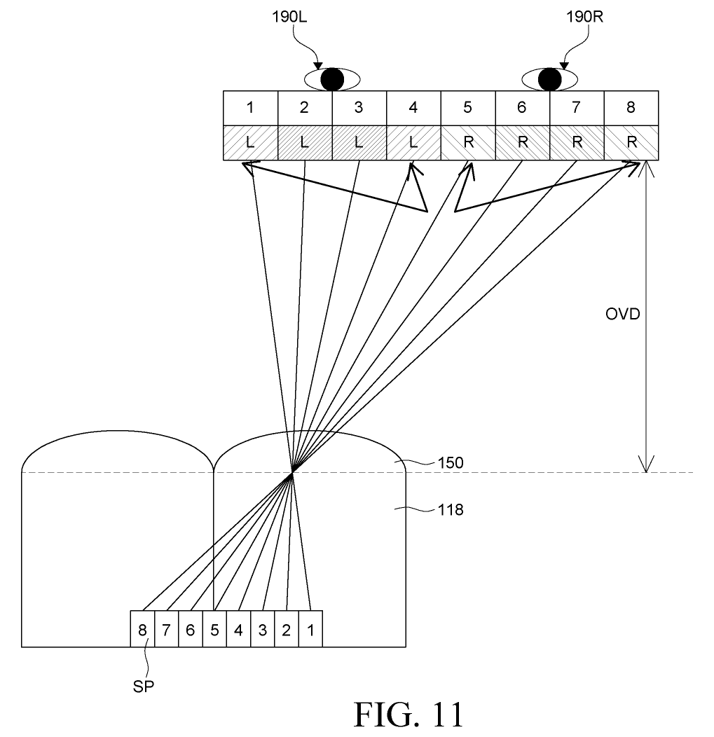

Next, a method of optimizing crosstalk according to a viewing angle (aberration) will be described in detail with reference to FIGS. 9A - 9C, FIGS. 10A -10C and FIG.11.

FIG. 9A is a diagram illustrating a state in which a stereoscopic image is viewed at a position where a viewing angle is slightly deviated from the front surface through a stereoscopic image display device according to an implementation of the present disclosure.

FIGS. 9B and 9C are graphs showing light profiles and crosstalk of images provided to the left eye and the right eye in the stereoscopic image display device of FIG. 9A.

FIG. 10A is a diagram illustrating a state in which a stereoscopic image is viewed at a position further outside a viewing angle through a stereoscopic image display device according to an implementation of the present disclosure.

FIGS. 10B and 10C are graphs showing optical profiles and crosstalk of images provided to the left eye and the right eye in the stereoscopic image display device of FIG. 10A.

In FIGS. 9B, 9C, 10B, and 10C, L represents a light profile of an image recognized in the left eye, and R represents a light profile of an image recognized in the right eye.

Referring to FIGS. 9A and 9B, when the viewing angle of the viewer in the stereoscopic image display device deviates from the front and changes to a certain angle (e.g., θ1), the aberration by the optical system occurs, which distorts the path of the image to be projected onto the left eye 190L or the right eye 190R. As a result, the leakage light generated in the unintended subpixel SP reaches the opposite eye, resulting in crosstalk.

In particular, the larger the viewing angle, the more the path of light is inclined on the display panel, so that the tendency of the output light of the specific subpixel SP to be dispersed to the adjacent subpixel SP or the opposite field of view increases. FIG. 9B illustrates a modified light distribution and a crosstalk graph according to a change in a viewing angle. It may be seen that crosstalk is concentrated in an area deviated from a central optical axis due to an aberration. For example, when the viewing angle is 15 degrees, the positions of both eyes still correspond to the lowest point of the crosstalk graph, but it may be seen that the overall level of the crosstalk graph has increased.

The crosstalk due to the viewing angle may be intensified as the viewer moves in the left-right or vertical direction based on the center of the screen.

Accordingly, as shown in FIGS. 9A and 9C, the light output or grayscale characteristics in units of the subpixel SP are corrected based on the viewing angle information to minimize crosstalk due to aberration.

For example, when the viewing angle of the viewer deviates from the front and changes to a predetermined angle (e.g. θ1), a method of lowering the grayscale value of the left and right (RL) outer and inner subpixels SP (indicated by dashed lines in FIG. 9A) is adopted to overlap the left and right images. It can alleviate the problem and reduce 3D crosstalk. That is, when the method of lowering the grayscale value of the left and right (RL) outer and inner subpixels SP is applied, the overall level of the crosstalk graph decreases and the slope becomes gentle, and accordingly, it may be seen that the 3D crosstalk effectively decreases. Accordingly, it is possible to minimize the distortion of the image according to the viewing angle of the viewer and solve the crosstalk problem. In this case, for example, when the viewer watches at a viewing angle of 15 degrees, it may be seen that the crosstalk is 1.58% before applying the grayscale value adjustment method, whereas the crosstalk is reduced to 1.17% after applying the grayscale value adjustment method.

Further, in some implementations of the present disclosure, the number of the left and right (RL) outer and inner subpixels SP which lower the grayscale value of the subpixels SP may be dynamically adjusted according to the size of the viewing angle of the viewer.

The larger the size of the viewing angle of the viewer, the wider the range of lowering the grayscale value of the left and right (RL) outer and inner subpixels SP is also expanded, so that the grayscale value of more subpixels SP is lowered, thereby more effectively preventing crosstalk. On the other hand, when the viewing angle of the viewer is close to the front, the number of subpixels SP that lowers the grayscale value is relatively small, and image distortion is minimized and an optimal 3D effect may be maintained. At this time, the left and right (RL) outer and inner subpixels SP refer to subpixels SP located at the outer and inner sides of each of the plurality of left and right (RL) subpixels SP forming one L-view and R-view.

In addition, referring to FIGS. 10A and 10B, when the viewing angle of the viewer in the stereoscopic image display device deviates from the front and changes to a larger angle (e.g., θ2), the aberration occurs larger, which causes the path of the image to be accurately projected onto the left eye 190L or the right eye 190R to be distorted larger. As a result, leakage light generated in more unintended subpixels SP reaches the opposite eye, resulting in larger crosstalk.

In particular, when the viewing angle becomes larger (e.g., θ2 > θ1), the traveling path of the light becomes more inclined on the display panel surface, thereby increasing the tendency that the output light of a specific subpixel SP is more dispersed in the adjacent subpixel SP or the opposite field of view. FIG. 10B illustrates a modified light distribution and a crosstalk graph according to an increase in the viewing angle. It may be seen that the crosstalk is more concentrated in an area deviated from the central optical axis due to aberrations. For example, when the viewing angle is 30 degrees, the positions of both eyes still correspond to the lowest point of the crosstalk graph, but it can be seen that the overall level of the crosstalk graph has increased significantly.

Accordingly, in some implementations of the present disclosure, as illustrated in FIGS. 10A and 10C, the crosstalk due to aberrations may be minimized by correcting the light output or grayscale value characteristics in units of the subpixel SP based on the viewing angle information.

For example, when the viewing angle of the viewer deviates from the front surface and becomes larger than a predetermined angle θ2, a method of lowering the grayscale value of the outer and inner subpixels SP in more left and right (RL) directions (indicated by dashed lines in FIG. 10A) is adopted to further mitigate the interference and overlapping of the left and right images, thereby suppressing the occurrence of crosstalk. That is, when the method of lowering the grayscale value of the outer and inner subpixels SP in more left and right (RL) directions is applied, the overall level of the crosstalk graph decreases and the slope becomes gentle, and accordingly, it may be seen that the 3D crosstalk effectively decreases. At this time, for example, when the viewer watches at a viewing angle of 30 degrees, it may be seen that the crosstalk is 9.61% before applying the grayscale value adjustment method, whereas the crosstalk is reduced to 6.37% after applying the grayscale value adjustment method.

In particular, according to the present disclosure, as the viewing angle of the viewer increases, the range of the subpixel SP that adjusts the grayscale value also expands in proportion. That is, the larger the viewing angle, the wider the grayscale value is lowered for more subpixels SP located at the outside and inside of the plurality of subpixels SP forming the L-view and R-view, thereby more effectively preventing crosstalk.

Hereinafter, an example in which the method of changing the subpixel grayscale of the present disclosure is applied to 3D crosstalk optimization according to the viewing angle in the case where each of the four subpixels forms one L-view and one R-view is to be described with reference to the drawings.

FIG. 11 is a diagram schematically illustrating a method of implementing a stereoscopic image display device by applying grayscale value adjustment of the present disclosure at a position where a viewing angle is slightly deviated from the front surface.

In FIG. 11, L represents a subpixel SP forming an L-view, and "R" represents a subpixel SP forming an R-view. As described above, the subpixels SP are actually disposed under the optical lens 150, but are provided to the left eye 190L and the right eye 190R, respectively, to visually correspond to the subpixels SP forming the left and right images.

Referring to FIG. 11, when a viewer watches an image at a position deviated from the front by a predetermined angle, even though each subpixel SP outputs an image corresponding to the left eye 190L or the right eye 190R, the quality of the stereoscopic image may deteriorate. This is because, as the eye position of the viewer deviates from the front reference, the traveling direction of the light refracted and output through the optical lens 150 changes, and accordingly, the L-view light to be reached to the left eye 190L partially flows into the right eye 190R, or, conversely, the R-view light flows into the left eye 190L.

This distortion of the optical path causes an error in aberration and field of view separation, resulting in interference between the left and right images, resulting in a crosstalk phenomenon.

Such a problem can be addressed by some implementations of the present disclosure, as illustrated in FIG. 11, illustrating an example of a method of adjusting the grayscale value in units of the subpixel SP based on the viewing angle information is applied. Specifically, among the subpixels SP corresponding to the left eye 190L and the right eye 190R, for example, by reducing the grayscale value of the outer and inner subpixels SP located at the boundary, such as subpixels SP No. 1 and No. 4 corresponding to L-views indicated by arrows in FIG. 11, and subpixels SP No. 5 and No. 8 corresponding to R-view, which correspond to the left eye 190L and the right eye 190R, parallax inconsistency and leakage light generated at the overlapping portion of the binocular image may be alleviated.

As described above, as the size of the viewing angle increases, a method of gradually lowering the grayscale value to the outer subpixel SP as well as the inner subpixel SP is applied so that luminance reduction may be performed for a wider range of subpixels SP. Accordingly, it is possible to effectively control the extended leakage area according to the change in the viewing angle and suppress crosstalk.

The grayscale value adjustment in units of the subpixel of the present disclosure maintains a clear separation between left and right images through fine luminance control and flexibly responds to a change in the position or viewing angle of a viewer, thereby maintaining an optimal 3D image quality and providing a stable three-dimensional effect even under various viewing conditions.

The stereoscopic image display device according to implementations of the present disclosure may be described as follows.

A stereoscopic image display device according to an example implementation of the present disclosure includes a display panel which sequentially assigns and outputs view data in the form of stereo from a first view to a mth view to each of m subpixels (where m is a natural number), and an optical lens which is disposed on a front surface of the display panel to separate an optical axis of the output view data to form a left-eye image (L-view image) and a right-eye image (R-view image) at a viewing distance, the display panel being capable of identifying a subpixel in which the L-view image and the R-view image are overlapping among the m subpixels according to a change in a position of a viewer, and adjusting a grayscale value of the identified subpixel to output the same.

According to another aspect of the present disclosure, the display panel may include a substrate divided into a plurality of subpixels, each subpixel including one emission area, a light emitting element disposed in the emission area of the substrate, and a color filter disposed above the light emitting element and overlapping the emission area.

According to yet another aspect of the present disclosure, the optical lens may be configured as a lenticular lens having a slanted structure disposed obliquely at a predetermined angle with respect to the subpixels.

According to yet another aspect of the present disclosure, when the viewer watches an image at a distance farther than an optimal viewing distance, the display panel may reduce the grayscale value of some subpixels located at the boundary between the left-eye subpixels and the right-eye subpixels forming the L-view image and the R-view image.

According to yet another aspect of the present disclosure, when the viewer watches an image at a distance closer than an optimal viewing distance, the display panel may reduce the grayscale value of some subpixels located outside each of the left-eye subpixels and the right-eye subpixels that form the L-view image and the R-view image.

According to yet another aspect of the present disclosure, when the viewer watches an image at a position deviated from the front surface by a predetermined angle, the display panel may reduce grayscale values of some subpixels located outside each of the left-eye subpixel and the right-eye subpixel forming the L-view image and the R-view image, and some other subpixels located at the boundary between the left-eye subpixels and the right-eye subpixels.

According to yet another aspect of the present disclosure, the optical lens may overlap the m subpixels.

According to yet another aspect of the present disclosure, when m is 8, first to fourth subpixels form the L-view image, and fifth to eighth subpixels may form the R-view image.

According to yet another aspect of the present disclosure, when the viewer watches an image at a distance farther than an optimal viewing distance, the display panel may reduce grayscale values of the fourth subpixel and the fifth subpixel.

According to yet another aspect of the present disclosure, when the viewer watches an image at a distance closer than an optimal viewing distance, the display panel may reduce grayscale values of the first subpixel and the eighth subpixel.

According to yet another aspect of the present disclosure, when the viewer watches an image at a position deviated from the front surface by a predetermined angle, the display panel may reduce grayscale values of the first subpixel, the fourth subpixel, the fifth subpixel, and the eighth subpixel.

A stereoscopic image display device according to another example implementation of the present disclosure includes a substrate divided into a plurality of subpixels, each subpixel including one emission area, a light emitting element disposed in the emission area of the substrate, a color filter disposed above the light emitting element and overlapping the emission area, and an optical lens disposed on a front surface of the color filter to form a left-eye image (L-view image) and a right-eye image (R-view image) at a viewing distance, and according to a change in the position of a viewer, a subpixel in which the L-view image and the R-view image overlap among the plurality of subpixels may be identified, and a grayscale value of the identified subpixel may be reduced and output.

According to another aspect of the present disclosure, when the viewer watches an image at a distance farther than an optimal viewing distance, the grayscale value of some subpixels located at the boundary between the left-eye subpixels and the right-eye subpixels forming the L-view image and the R-view image may be reduced.

According to yet another aspect of the present disclosure, when the viewer watches an image at a distance closer than an optimal viewing distance, the grayscale value of some subpixels located outside each of the left-eye subpixels and the right-eye subpixels forming the L-view image and the R-view image may be reduced.

According to yet another aspect of the present disclosure, when the viewer watches an image at a position deviated from the front surface by a predetermined angle, grayscale values of some subpixels located outside each of the left-eye subpixels and right-eye subpixels forming the L-view image and the R-view image and some other subpixels located at the boundary between the left-eye subpixels and the right-eye subpixels may be reduced.

According to yet another aspect of the present disclosure, according to the change in the position of the viewer, the grayscale value of the identified subpixel may be reduced and output so that the crosstalk of the point corresponding to positions of both eyes of the viewer is less than or equal to a level of the crosstalk at the optimal viewing distance.

A stereoscopic image display device according to another example implementation of the present disclosure, the stereoscopic image display apparatus comprising: a display panel, wherein the display panel outputs view data through one or more subpixels; a light separation element disposed over the display panel, wherein the view data output from the display panel passes through the light separation element to provide a binocular parallax image, the binocular parallax image comprising a left-eye image and a right-eye image ; and wherein the left-eye image has a left-eye first light distribution region in a region at a center of the left-eye image, and a left-eye second light distribution region in an overlapping region with the right-eye image; wherein the right-eye image has a right-eye first light distribution region in a region at a center of the right-eye image, and a right-eye second light distribution region in an overlapping region with the left-eye image ; and wherein the stereoscopic image display apparatus is configured to, when a viewing region is not located in the region at the center of the left-eye image or the region at the center of the right-eye image, reduce a light distribution intensity of the right-eye second light distribution region and/or reduce a light distribution intensity of the left-eye second light distribution region to reduce crosstalk between the left-eye image and the right-eye image.

According to yet another aspect of the present disclosure, wherein a light distribution intensity of the left-eye first light distribution region is greater than a light distribution intensity of the left-eye second light distribution region; and a light distribution intensity of the right-eye first light distribution region is greater than a light distribution intensity of the right-eye second light distribution region.

According to yet another aspect of the present disclosure, wherein in the region at the center of the left-eye image, a light distribution intensity of the right-eye second light distribution region is substantially 0; and in the region at the center of the right-eye image, a light distribution intensity of the left-eye second light distribution region is substantially 0.

According to yet another aspect of the present disclosure, wherein in the region at the center of the left-eye image and in the region at the center of the right-eye image, the left-eye image and the right-eye image have relatively strongest light distributions, respectively.

According to yet another aspect of the present disclosure the stereoscopic image display apparatus is a light field display apparatus, and the light separation element is a lenticular lens.

Although the example implementations of the present disclosure have been described in detail with reference to the accompanying drawings, the present disclosure is not limited thereto and may be embodied in various forms without departing from the technical concept of the present disclosure. Therefore, the example implementations of the present disclosure are provided for illustrative purposes only but not intended to limit the technical concept of the present disclosure. The scope of the technical concept of the present disclosure is not limited thereto. Therefore, it should be understood that the above-described implementations are illustrative in all implementations and do not limit the present disclosure. The protective scope of the present disclosure should be construed based on the following claims, and all the technical concepts in the equivalent scope thereof should be construed as falling within the scope of the present disclosure.

What is claimed is:

1. A stereoscopic image display device, comprising:
a display panel configured to sequentially assign and output view data for m stereoscopic views respectively to m subpixels, where m is a natural number; and
an optical lens which is disposed on a front surface of the display panel and configured to separate an optical axis of the output view data and form (i) a left-eye image expressed as an L-view image at a viewing distance and (ii) a right-eye image expressed as an R-view image at the viewing distance,
wherein the display panel is configured to identify a subpixel, among the m subpixels, in which the L-view image and the R-view image are overlapping according to a change in a position of a viewer, and adjust and output a grayscale value of the identified subpixel.

2. The stereoscopic image display device according to claim 1, wherein the display panel includes:
a substrate divided into a plurality of subpixels including the m subpixels, each subpixel including one emission area; and
for each subpixel:
a light emitting element disposed in the emission area of the subpixel; and
a color filter disposed above the light emitting element and overlapping the emission area of the subpixel.

3. The stereoscopic image display device according to claim 1, wherein the optical lens comprises a lenticular lens having a slanted structure obliquely disposed at an angle with respect to the plurality of subpixels in a plan view of the image display device.

4. The stereoscopic image display device according to claim 1, wherein based on the viewer watching an image at a distance farther than an optimal viewing distance from the front surface, the display panel is configured to reduce a grayscale value of at least one subpixel located at a boundary between left-eye subpixels forming the L-view image and right-eye subpixels forming the R-view image.

5. The stereoscopic image display device according to claim 1, wherein based on the viewer watching an image at a distance closer than an optimal viewing distance from the front surface, the display panel is configured to reduce a grayscale value of at least one subpixel located outside each of left-eye subpixels forming the L-view image and right-eye subpixels forming the R-view image.

6. The stereoscopic image display device according to claim 1, wherein based on the viewer watching an image at a position deviated from the front surface by an angle, the display panel is configured to reduce grayscale values of at least one first subpixel located outside each of left-eye subpixels forming the L-view image and right-eye subpixels forming the R-view image, and at least one second subpixel located at a boundary between the left-eye subpixels and the right-eye subpixels.

7. The stereoscopic image display device according to claim 1, wherein the optical lens overlaps the m subpixels.

8. The stereoscopic image display device according to claim 1, wherein based on m being equal to 8, first to fourth subpixels form the L-view image, and fifth to eighth subpixels form the R-view image.

9. The stereoscopic image display device according to claim 8, wherein based on the viewer watching an image at a distance farther than an optimal viewing distance from the front surface, the display panel is configured to reduce grayscale values of the fourth subpixel and the fifth subpixel.

10. The stereoscopic image display device according to claim 8, wherein based on the viewer watching an image at a distance closer than an optimal viewing distance from the front surface, the display panel is configured to reduce grayscale values of the first subpixel and the eighth subpixel.

11. The stereoscopic image display device according to claim 8, wherein based on the viewer watching an image at a position deviated from the front surface by a predetermined angle, the display panel is configured to reduce a grayscale value of the first subpixel, the fourth subpixel, the fifth subpixel and the eighth subpixel.

12. A stereoscopic image display device, comprising:
a substrate comprising a plurality of subpixels, each subpixel including an emission area;
for each of the plurality of subpixels:
a light emitting element disposed in the emission area of the subpixel; and
a color filter disposed above the light emitting element and overlapping the emission area of the subpixel; and
an optical lens disposed on a front surface of the color filter and configured to form (i) a left-eye image expressed as L-view image at a viewing distance and (ii) a right-eye image expressed as R-view image at a viewing distance,
wherein according to a change in the position of a viewer, the stereoscopic image display device is configured to reduce and output a grayscale value for a subpixel, among the plurality of subpixels, in which the L-view image and the R-view image are overlapping.

13. The stereoscopic image display device according to claim 12, wherein based on the viewer watching an image at a distance farther than an optimal viewing distance from the front surface, grayscale values of at least one subpixel located at a boundary between left-eye subpixels which form the L-view image and the right-eye subpixels which form the R-view image are reduced.

14. The stereoscopic image display device according to claim 12, wherein based on the viewer watching an image at a distance closer than an optimal viewing distance from the front surface, grayscale values of at least one subpixel located outside each of the left-eye subpixels which form the L-view image and right-eye subpixels which form the R-view image are reduced.

15. The stereoscopic image display device according to claim 12, wherein based on the viewer watching an image at a position deviated from the front surface by an angle, a grayscale value of at least one first subpixel located outside each of left-eye subpixels forming the L-view image and right-eye subpixels forming the R-view image and at least one second subpixel located at a boundary between the left-eye subpixels and the right-eye subpixels are reduced.

16. A stereoscopic image display device according to claim 1, wherein the display panel is configured to reduce and output the grayscale value of the identified subpixel so that the crosstalk of a point corresponding to positions of both eyes of the viewer is less than or equal to a level of crosstalk at an optimal viewing distance according to a change in the position of the viewer.

17. A stereoscopic image display apparatus, comprising:
a display panel configured to output view data through one or more subpixels;
a light separation element disposed over the display panel, wherein the view data that is output from the display panel passes through the light separation element to provide a binocular parallax image, the binocular parallax image comprising a left-eye image and a right-eye image; and
wherein the left-eye image has (i) a left-eye first light distribution region in a region at a center of the left-eye image, and (ii) a left-eye second light distribution region in an overlapping region with the right-eye image;
wherein the right-eye image has (i) a right-eye first light distribution region in a region at a center of the right-eye image, and (ii) a right-eye second light distribution region in an overlapping region with the left-eye image; and
wherein the stereoscopic image display apparatus is configured to, when a viewing region is not located in the region at the center of the left-eye image or the region at the center of the right-eye image, reduce a light distribution intensity of the right-eye second light distribution region and/or reduce a light distribution intensity of the left-eye second light distribution region to reduce crosstalk between the left-eye image and the right-eye image.

18. The stereoscopic image display apparatus according to claim 17,
wherein a light distribution intensity of the left-eye first light distribution region is greater than a light distribution intensity of the left-eye second light distribution region,
wherein a light distribution intensity of the right-eye first light distribution region is greater than a light distribution intensity of the right-eye second light distribution region, and
wherein, in a region at the center of the left-eye image and in a region at the center of the right-eye image, the left-eye image and the right-eye image have relatively strongest light distributions, respectively.

19. The stereoscopic image display apparatus according to claim 17,
wherein in the region at the center of the left-eye image, a light distribution intensity of the right-eye second light distribution region is substantially 0; and
in the region at the center of the right-eye image, a light distribution intensity of the left-eye second light distribution region is substantially 0.

20. The stereoscopic image display apparatus according to claim 18, wherein the stereoscopic image display apparatus comprises a light field display apparatus, and the light separation element comprises a lenticular lens.
